(19) United States
(12) Patent Application Publication
(10) Pub. No.: US 2026/0178571 A1
(43) Pub. Date: Jun. 25, 2026

(54) Adaptive Learning Framework for Large Language Models

(71) Applicant: Cisco Technology, Inc., San Jose, CA (US)

(72) Inventors: Mohammed Hamzeh, Richardson, TX (US); David C White, Maitland, FL (US)

(21) Appl. No.: 19/072,891

(22) Filed: Mar. 6, 2025

Related U.S. Application Data
(60) Provisional application No. 63/738,722, filed on Dec. 24, 2024.

(51) Int. Cl. G06F 16/242; G06F 16/23

(52) U.S. Cl. CPC G06F 16/243; G06F 16/2365

(57) ABSTRACT

Systems and methods for automated adaptive learning framework for large language models are provided. A method includes receiving one or more input parameters, including at least one of a user query, an automated response, or a validated response. The automated response is based on a prompt. The method further includes providing the one or more input parameters and an input analysis prompt to a first large language model, and receiving an analysis report from the first large language model. Furthermore, the method includes providing the one or more input parameters and the analysis report to one of the first large language model or a second large language model, and receiving a learned memory from one of the first large language model or the second large language model. The method also includes generating an updated prompt through memory injection of the learned memory into the prompt.

### CROSS-REFERENCE TO RELATED APPLICATIONS

This application claims priority to U.S. Provisional Application No. 63/738,722, filed Dec. 24, 2024, the entirety of which is incorporated herein by reference.

### FIELD

The present disclosure relates to Artificial Intelligence (AI)-based systems. More particularly, the present disclosure relates to adaptive learning framework for Large Language Models (LLMs).

### BACKGROUND

Large Language Models (LLMs) are increasingly deployed in dynamic environments to perform a wide range of tasks, such as answering complex queries across various domains, including security, networking, and others, as well as providing real-time solutions in rapidly evolving scenarios. However, as LLMs are tasked with handling a diverse set of complex queries, prompts (e.g., system generated instructions that guide the LLMs' responses) can expand in scope, becoming increasingly difficult to manage. As query complexity increases, so does the size of the prompts, which in turn requires significant computational resources. This can present a challenge, making it costly and difficult to deploy LLMs effectively in environments that demand quick adaptation and real-time or near-real time responses.

Furthermore, reliability remains a significant concern for LLMs. While LLMs can generate responses that may appear to be plausible, the LLMs may sometimes provide answers that are inaccurate or irrelevant. To address this issue, techniques such as Retrieval Augmented Generation (RAG) have been developed, enabling LLMs to incorporate external data to enhance the accuracy of their responses. However, as the scope of topics and queries expands, the effectiveness of RAG may reduce due to the large volume of data which must be searched, making it more difficult to maintain reliable results. Moreover, to ensure ongoing accuracy, RAG-based systems may require continuous updates, which demands significant human effort and time. These challenges can result in a substantial operational burden, with frequent human intervention required to adjust prompts and maintain the RAG-based systems. Therefore, the above-mentioned issues may hinder efficiency, scalability, and reliability of LLMs, requiring constant human oversight and resources.

### SUMMARY OF THE DISCLOSURE

Systems and methods for adaptive learning framework for large language models in accordance with embodiments of the disclosure are described herein. In many embodiments, a system may include a processor and a memory communicatively coupled to the processor. The memory may include an adaptive learning logic that may be configured to receive one or more input parameters, including at least one of a user query, an automated response, or a validated response. The automated response and the validated response may be associated with the user query. The adaptive learning logic may further be configured to provide, as a first input, the one or more input parameters and an input analysis prompt to a first large language model. Furthermore, the adaptive learning logic may further be configured to receive an analysis report from the first large language model based on the first input. The adaptive learning logic may further be configured to provide, as a second input, the one or more input parameters and the analysis report to one of the first large language model or a second large language model. Further, the adaptive learning logic may be configured to receive a learned memory from one of the first large language model or the second large language model based on the second input. Upon receiving the learned memory, the adaptive learning logic may be configured to generate an updated prompt through memory injection of the learned memory into a prompt.

In a number of embodiments, the automated response may be based on the prompt.

In a variety of embodiments, the automated response may be from an Artificial Intelligence (AI) agent, based on the prompt, in response to the user query.

In various embodiments, the adaptive learning logic may be further configured to generate the input analysis prompt based on the one or more input parameters.

In more embodiments, the analysis report may include at least one of a result of a comparison between the automated response and the validated response, an identification of one or more output divergences in the automated response compared to the validated response, or at least one factor for the one or more output divergences.

In additional embodiments, the adaptive learning logic may further be configured to validate the learned memory.

In further embodiments, to validate the learned memory, the adaptive learning logic may further be configured to provide the user query and the updated prompt to an Artificial Intelligence (AI) agent, and receive, in response to providing the user query and the updated prompt to the AI agent, an updated automated response from the AI agent for the user query.

In still more embodiments, to validate the learned memory, the adaptive learning logic may further be configured to compare the updated automated response with the validated response using one of the first large language model, the second large language model, or a third large language model, and receive, based on the comparison, an indication that the learned memory is successfully validated.

In still further embodiments, the adaptive learning logic may further be configured to store at least one of the learned memory or the updated prompt in a database based on the received indication.

In still additional embodiments, the learned memory may be associated with a configured time-period.

In some more embodiments, the adaptive learning logic may further be configured to delete the stored learned memory from the database upon an expiration of the configured time-period.

In yet various embodiments, based on the indication that the learned memory is successfully validated, the adaptive learning logic may further be configured to create a plurality of variations of the user query, encode at least one variation of the plurality of variations into an embedding vector, map the learned memory to the embedding vector, and store at least one of the learned memory or the embedding vector in a database.

In yet more embodiments, to validate the learned memory, the adaptive learning logic may further be configured to compare the updated automated response with the validated response using one of the first large language model, the second large language model, or a third large language model, receive, based on the comparison, an indication that the validation of the learned memory has failed, and re-learn, in response to the indication that the validation of the learned memory has failed, a new learned memory using at least one of the first large language model or the second large language model.

In still yet more embodiments, the re-learning of the new learned memory may be based on at least one of the updated automated response, the validated response, or the user query.

In several embodiments, a system may include a processor and a memory communicatively coupled to the processor. The memory may include an adaptive learning logic that may be configured to receive a user query. The adaptive learning logic may be configured to encode the user query into an embedding vector. Further, the adaptive learning logic may be configured to identify, from one or more historical user queries, a historical user query that has a similarity score with the embedding vector exceeding a threshold score. Furthermore, the adaptive learning logic may be configured to retrieve a learned memory mapped to the identified historical user query and generate an updated prompt through memory injection of the retrieved learned memory into a prompt. Also, the adaptive learning logic may be configured to receive a response to the user query based on the updated prompt.

In a number of embodiments, to receive the response to the user query, the adaptive learning logic may further be configured to provide, as an input, the user query and the updated prompt to an Artificial Intelligence (AI) agent, and receive the response as an output of the AI agent for the provided input.

In more embodiments, the adaptive learning logic may further be configured to validate the received response.

In furthermore embodiments, a result of the validation may include one of a first indication of acceptance of the received response or a second indication of rejection of the received response.

In several more embodiments, a method may include receiving one or more input parameters, including at least one of a user query, an automated response, or a validated response, where the automated response and the validated response may be associated with the user query, and the automated response may be based on a prompt. The method may further include providing as a first input, the one or more input parameters and an input analysis prompt to a first large language model. Furthermore, the method may include receiving an analysis report from the first large language model based on the first input, and providing, as a second input, the one or more input parameters and the analysis report to one of the first large language model or a second large language model. The method may include receiving a learned memory from one of the first large language model or the second large language model based on the second input. Further, the method may generate an updated prompt through memory injection of the learned memory into the prompt.

In various embodiments, the method further comprising validating the learned memory, and storing the learned memory in a database in response to successful validation of the learned memory.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a distributed network architecture including an adaptive learning system that implements an adaptive learning framework for large language models in accordance with various embodiments of the disclosure;

FIG. 2 is a detailed schematic diagram of a process for generating a validated response for a user query in accordance with various embodiments of the disclosure;

FIG. 3 is a detailed schematic diagram of a process for generation and validation of a learned memory for an adaptive learning system in accordance with various embodiments of the disclosure;

FIG. 4 is a detailed schematic diagram of a process of generating an updated prompt through memory injection of a retrieved learned memory into a prompt for an Artificial Intelligence (AI) agent in accordance with various embodiments of the disclosure;

FIG. 5 is a schematic diagram illustrating various subsets of artificial intelligence in accordance with various embodiments of the disclosure;

FIG. 6 is a block diagram illustrating different methods of machine-based learning in accordance with various embodiments of the disclosure;

FIG. 7 is a block diagram illustrating a machine learning lifecycle in accordance with various embodiments of the disclosure;

FIG. 8 is a schematic diagram illustrating an exemplary neural network in accordance with various embodiments of the disclosure;

FIG. 9 is a flowchart depicting a process for generating an updated prompt through memory injection of a learned memory into a prompt in accordance with various embodiments of the disclosure;

FIG. 10 is a flowchart depicting a process for re-learning a new learned memory upon an unsuccessful validation of an existing learned memory in accordance with various embodiments of the disclosure;

FIG. 11 is a flowchart depicting a process for mapping a learned memory to one or more variations of a user query in accordance with various embodiments of the disclosure;

FIG. 12 is a flowchart depicting a process for validating a response and rendering the validated response on a user device as an output for a received user query in accordance with various embodiments of the disclosure; and

FIG. 13 is a conceptual block diagram of a device capable of executing components and an adaptive learning logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems and methods are discussed herein for adaptive learning framework for large language models. Techniques such as Retrieval Augmented Generation (RAG) have been developed, enabling large language models to incorporate external data to enhance the accuracy of their responses. However, as the scope of topics and queries expands, the effectiveness of RAG can reduce due to the large volume of data that must be searched, making it more difficult to maintain reliable results. Moreover, to ensure ongoing accuracy, RAG-based systems may require continuous updates, which demand significant human effort and time. These challenges can result in a substantial operational burden, with frequent human intervention required to adjust prompts and maintain the RAG-based systems. Therefore, the above-mentioned issues hinder efficiency, scalability, and reliability of large language models, requiring constant human oversight and resources.

Thus, in many embodiments, an adaptive learning system is provided to continuously enhance the performance of Artificial Intelligence (AI) agents by leveraging learned memories, validation processes, and large language models. The adaptive learning system operates in two phases: the learning phase and the implementation phase. During the learning phase, the adaptive learning system may autonomously acquire, validate, and store new memories based on user queries and responses, using inputs from various large language models and human experts (for example, a human in loop). These learned memories can be further refined through comparison between automated and validated responses, and the system may then generate an updated prompt that incorporates the learned information.

In the implementation phase, the adaptive learning system may use the stored memories to improve real-time query handling. When a new query is received, the adaptive learning system may match the received query with historical queries stored in a vector database, retrieve relevant learned memories, and generate an updated response based on this information. This process may further include continuous validation and refinement of responses, ensuring that the adaptive learning system provides more accurate, contextually relevant, and efficient responses with every iteration.

By incorporating multiple phases, feedback loops, and the use of advanced models, the adaptive learning system may enhance the overall responsiveness and efficiency of AI agents, ensuring continuous improvement of their performance and increasing the accuracy and relevance of responses over time. The adaptive learning system's ability to adapt to evolving needs and validate learned memories may contribute to the ongoing optimization of query handling within distributed network architecture.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in many additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in numerous embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including antazonite embodiments of like elements.

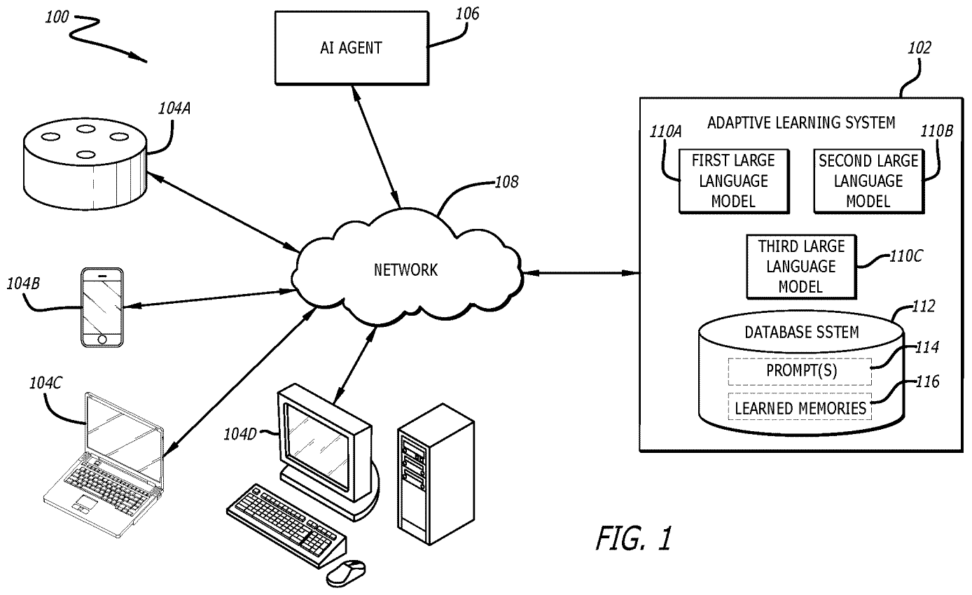

Referring to FIG. 1, a schematic diagram of a distributed network architecture 100 including an adaptive learning system 102 that implements an adaptive learning framework for large language models in accordance with various embodiments of the disclosure is shown. In the distributed network architecture 100, components such as hardware, software, and data are distributed across multiple geographical regions and interconnected devices or nodes. These components may collaborate to perform functions, share resources, and provide services, while operating across a network.

As shown in FIG. 1, in various embodiments, the distributed network architecture 100 may include the adaptive learning system 102 (hereinafter, interchangeably referred to as the “system 102”), a plurality of user devices 104A, 104B, 104C, and 104D (hereinafter, collectively referred to as the “plurality of user devices 104A-D”), an Artificial Intelligence (AI) agent 106, and a network 108. In a variety of embodiments, the adaptive learning system 102, the plurality of user devices 104A-D, and the AI agent 106 may be communicatively coupled to the network 108, which facilitates communication between the adaptive learning system 102, the plurality of user devices 104A-D, and the AI agent 106. Although four user devices 104A, 104B, 104C, and 104D are illustrated in FIG. 1 for the sake of brevity, it may be understood that the distributed network architecture 100 can include any number of user devices.

In various embodiments, the adaptive learning system 102 may be owned, managed, or otherwise associated with an organization, enterprise, or any authorized entity. The adaptive learning system 102 may be implemented across various computing platforms, including mainframe computers, servers, networked servers, cloud environments, and edge devices. In many embodiments, the adaptive learning system 102 may be deployed across a range of operational environments, such as customer support, healthcare, education, e-commerce, retail, finance, legal, and other industries. The adaptive learning system 102 may be integrated into enterprise infrastructures or specialized applications tailored to the needs of these environments. Additionally, the adaptive learning system 102 may be deployed in either on-premises or cloud-based environments to enhance scalability, security, and performance.

In a number of embodiments, the adaptive learning system 102 may implement an adaptive learning framework. The adaptive learning system 102 may be responsible for continuously acquiring, validating, and storing learned memories based on user queries, responses, and feedback on the responses. In an example, a user query may represent a request for information, assistance with a task, or completion of a specific action. In response to the user query, an AI agent may generate an answer (i.e., a response) based on an autonomous interpretation of the user query, aimed at providing the necessary information, assisting with the task, or completing the specified action. The response may involve retrieving relevant data, providing suggestions, executing instructions, or offering explanations, depending on the nature of the user query. Feedback for a response may refer to information or evaluations regarding the quality, relevance, accuracy, or completeness of the generated response. The feedback may be utilized to assess the effectiveness of the response, and refine and improve future responses or the overall performance of the AI agent. In many embodiments, a learned memory may refer to information captured from past interactions between an AI agent and a user, and/or feedback received from a human expert. This information may enable the AI agent to enhance its performance when responding to future queries. Learned memories may be created through ongoing learning from historical data, user queries, and past interactions, enabling the AI agent to adapt and refine its performance over time.

In yet various embodiments, the adaptive learning framework, employed by the adaptive learning system 102, may enable the adaptive learning system 102 to adapt over time, improving the accuracy, relevance, and contextuality of the responses generated by AI agents (for example, the AI agent 106). This may ensure that the adaptive learning system 102 provides accurate and insightful responses for future interactions. The adaptive learning system 102 may include hardware components, such as a processor, memory, and network interfaces, which support the implementation of the adaptive learning framework.

The network interfaces may allow the adaptive learning system 102 to communicate with the plurality of user devices 104A-D, the AI agent 106, and other system components, thereby facilitating coordination. In several embodiments, the adaptive learning system 102 may implement an adaptive learning logic, stored in the memory or embodied as a standalone component within the adaptive learning system 102, to efficiently implement the adaptive learning framework.

In one or more embodiments, the plurality of user devices 104A-D may be capable of exchanging information with the adaptive learning system 102 and the AI agent 106 via the network 108. In more embodiments, each of the plurality of user devices 104A-D may be any device utilized by a user. In examples, the user may be any individual who can interact with the adaptive learning system 102 to seek a response to a query. Further, the user query may refer to an input provided by the user, typically in the form of a question or request, seeking information, assistance, or resolution of a particular issue. In a non-limiting example, a user of the user device 104A may submit a query such as “What are the available options for exporting data from a system?” to the adaptive learning system 102 to seek a response. Further, in examples, the user query may be in form of a text, voice, image, or the like.

In still more embodiments, each of the plurality of user devices 104A-D may be any computing device, such as a desktop computer, a laptop, a mobile device, a Personal Digital Assistant (PDA), a virtual assistant-enabled device, a wearable device, or any other computing device. Further, each of the plurality of user devices 104A-D may include a user interface such as a keyboard, a mouse, a touch screen, or any other appropriate user interface. The user interface may enable each of the plurality of user devices 104A-D to communicate with other devices and systems, such as the adaptive learning system 102. In some more embodiments, each of the plurality of user devices 104A-D may include a display, such as a screen, a monitor connected thereto in any manner, or any other appropriate display. In several embodiments, each of the plurality of user devices 104A-D may submit a user query to the adaptive learning system 102 via a respective user interface and view a response to the query, provided by the adaptive learning system 102 on a respective display.

In further embodiments, the AI agent 106 may be a composite, autonomous software entity designed to process user queries and generate appropriate responses within a distributed network architecture. The AI agent 106 may include multiple sub-agents, which may be developed by different entities or internal teams. These sub-agents may collaborate under the control of the AI agent 106, enabling the overall system to process user queries more efficiently by leveraging the specialized capabilities of each sub-agent. The AI agent 106 may operate based on a defined AI model that governs its decision-making process, as well as a set of tools that allow the agent to interpret and process user queries. These tools, in conjunction with the AI model, may enable the AI agent 106 to understand the nature of a given query, assess the context and intent behind the query, and generate an appropriate response. Additionally, the AI agent 106 may include components such as data retrieval mechanisms for accessing relevant information, reasoning algorithms for selecting the most relevant response, and a feedback system for improving the quality of future responses. The distributed network architecture 100 may support multiple AI agents or sub-agents, either operating independently or collaboratively, across various systems, organizational units, or geographical locations, ensuring efficient query processing and response generation. Although, the AI agent 106 is described as being external to the adaptive learning system 102, it may be understood that in various embodiments, the AI agent 106 may also be integrated within the adaptive learning system 102.

In many further embodiments, the network 108 may encompass a wide range of network types and communication infrastructures, including but not limited to, a Wireless Fidelity (Wi-Fi) network, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, and a combination thereof. The network 108 may provide the necessary communication infrastructure for the various components of the distributed network architecture 100, such as the adaptive learning system 102, the plurality of user devices 104A-D, and the AI agent 106, to exchange data and coordinate tasks effectively.

In additional embodiments, the network 108 may support both wired and wireless communication protocols, depending on the specific configuration and operational needs of the distributed network architecture 100. For example, wired communication protocols may include Ethernet over LAN or fiber optic connections, while wireless communication may be facilitated through protocols like Wi-Fi, LTE, or other wireless communication standards. The distributed network architecture 100 can also leverage various communication protocols, including but not limited to, Transmission Control Protocol and Internet Protocol (TCP/IP), User Datagram Protocol (UDP), Long Term Evolution (LTE) communication protocols, Application Programming Interface (API) protocols, or any combination of these or other suitable protocols. This flexibility in the network 108 and communication protocols may allow for seamless integration and operation of the distributed network architecture 100 across diverse network environments.

In several more embodiments, the adaptive learning system 102 may include a first large language model 110A, a second large language model 110B, and a third large language model 110C (interchangeably referred to as the “first LLM 110A”, “second LLM 110B”, and the “third LLM 110C”, respectively). In further embodiments, the adaptive learning system 102 may also include a database 112. In a non-limiting example, the database 112 may be a vector database. The database 112 may include prompt(s) 114 (individually referred to as a “prompt 114”) and one or more learned memories 116 (individually referred to as a “learned memory 116”). The prompt(s) 114 may include system prompts, updated system prompts, or any other type of prompts and updated prompts. In an example, a prompt may be a set of instructions or guidelines that provide context and direction to an AI agent on how to interpret a user query and generate an appropriate response. The prompt may include one or more directives related to structure, tone, depth, and content of the response, depending on specific requirements of the user query. In an example, the user query may represent a request for information, assistance, or completion of a particular task. In various embodiments, the prompt may be generated dynamically in response to the user query to guide the AI agent in providing a relevant, accurate, and contextually appropriate response. A learned memory may refer to information captured from past interactions between an AI agent and a user, and/or feedback received from a human expert, which the AI agent may use to enhance its performance in generating responses to user queries. Learned memory may be created through ongoing learning from historical data, user queries, and the results of past interactions, enabling the AI agent to adapt and refine its performance over time.

In still various embodiments, the database 112 may be organized into separate sections or spaces, each corresponding to a specific domain in which the AI agent 106 operates. Each domain may represent a particular area of expertise or operational context, such as customer support, healthcare, finance, or any other relevant domain. Each learned memory 116 may be stored within a domain-specific space that corresponds to the particular domain of the user queries. This organizational structure may ensure that the learned memories 116 are appropriately classified and accessible based on the context in which it is needed, allowing an AI agent to retrieve and apply domain-relevant knowledge more effectively when generating responses. For example, learned memories 116 related to user queries in the healthcare domain may be stored within the healthcare-specific space of the database 112, while those related to customer support may be stored in the customer support-specific space of the database 112. In an example, the domain-specific space in the database 112 may refer a memory space mapped to a particular domain. This domain-specific structure may enable more accurate, contextually appropriate responses from the AI agent 106 by ensuring that the AI agent 106 obtains most relevant and specialized information.

Although the database 112 is shown internal to the adaptive learning system 102, it may be understood that the database 112 may also be implemented external to the adaptive learning system 102, where the database 112 may be communicatively coupled to the adaptive learning system 102. Further, the prompt(s) 114 and the learned memories 116 stored in the database 112 may be retrieved whenever a response is to be generated for a user query. Furthermore, the prompt(s) 114 and the learned memories 116 contained within the database 112 may be periodically updated. For example, new prompt and new memories may be added into the database 112, existing prompt(s) 114 and learned memories 116 may be modified, or deleted from the database 112 (for example, upon expiration of a configured time-period).

In yet more embodiments, each of the first large language model 110A, the second large language model 110B, and the third large language model 110C may operate as a computationally intensive system that can leverage high-performance hardware components to execute complex algorithms and handle vast amounts of data. Each of the first large language model 110A, the second large language model 110B, and the third large language model 110C may be deployed on hardware infrastructure, which includes high-speed processors, large-scale memory systems, and optimized storage architectures, all interconnected through high-throughput network interfaces.

In several additional embodiments, each of the first large language model 110A, the second large language model 110B, and the third large language model 110C may be configured to perform specific tasks within the adaptive learning framework, contributing to the ability of the adaptive learning system 102 to continuously improve and provide more refined responses over time. In further embodiments, each of the first large language model 110A, the second large language model 110B, and the third large language model 110C may be trained on vast datasets, incorporating diverse knowledge from multiple domains, and may undergo continuous fine-tuning. This enables each of the first large language model 110A, the second large language model 110B, and the third large language model 110C to improve performance through continuous learning from new data, user queries, feedback, and outcomes. The first large language model 110A, the second large language model 110B, and the third large language model 110C can work independently or in conjunction, enabling the adaptive learning system 102 to generate more accurate, contextually relevant, and insightful responses to user queries. The integration of the first large language model 110A, the second large language model 110B, and the third large language model 110C may allow the adaptive learning system 102 to enhance response quality by leveraging domain expertise, continuous learning, and memory-based feedback. In various embodiments, each of the first large language model 110A, the second large language model 110B, and the third large language model 110C may function independently as an AI agent, performing different roles or tasks within the adaptive learning system 102.

In yet many embodiments, the first large language model 110A may function as a domain expert within the adaptive learning system 102. In such embodiments, the first large language model 110A may be configured to analyze user queries and responses generated by the AI agent 106 to evaluate accuracy of the responses provided by the AI agent 106. In still yet more embodiments, the second large language model 110B may receive feedback and insights from the first large language model 110A. The second large language model 110B may record knowledge, technical insights, and contextual information that can be utilized to improve future response generation. The second large language model 110B may be configured to generate the learned memories 116 based on past interactions, feedback, and domain expertise. In still many embodiments, the third large language model 110C may be configured to perform a validation process to validate the learned memories 116. This validation process may ensure that the learned memories 116 are accurate, consistent, and effective for generating future responses.

Although specific roles are defined for the first large language model 110A, the second large language model 110B, and the third large language model 110C, it may be understood that these roles may be interchangeable in various embodiments. Depending on the specific implementation and requirements of the adaptive learning system 102, any of the first large language model 110A, the second large language model 110B, or the third large language model 110C may be configured to perform the functions of another, providing flexibility and adaptability in tasks such as analysis, validation, memory creation, and response generation. In further embodiments, a single large language model can be configured to execute the roles of the first large language model 110A, the second large language model 110B, and the third large language model 110C.

In numerous embodiments, the adaptive learning system 102 may be configured to employ the adaptive learning framework implemented in two phases, such as a first phase and a second phase. The first phase, also referred to as the learning phase, may involve autonomous acquisition of new memories by the adaptive learning system 102. During this first phase, the adaptive learning system 102 may autonomously acquire, validate, and store new memories based on feedback and input from the first large language model 110A, the second large language model 110B, the third large language model 110C, and/or one or more human experts. The second phase, also referred to as the implementation phase, may occur after the acquisition of new memories. In the implementation phase, the adaptive learning system 102 may leverage the learned memories in real-time or near-real time for generation and validation of responses to subsequent user queries. It may be understood that acquisition of new learned memories and lookup of previously learned memories may occur at any time during system operation. For example, a memory lookup may be performed for each user query. When a match is found (e.g., a learned memory), the learned memory may be injected into a system prompt or any other relevant prompt to provide real-time learning to any of the first large language model 110A, the second large language model 110B, or the third large language model 110C. The details of the first phase (learning phase) and second phase (implementation phase) are described below.

During the learning phase, the adaptive learning system 102 may receive one or more input parameters, which may include at least one of a user query, an automated response, or a validated response. The automated response and the validated response may be associated with the user query. For example, the user query may represent a request for information, assistance with a task, or completion of a specific action. The user query may also be a question or problem statement provided by a user. In response to the user query, the adaptive learning system 102 may receive the automated response from the AI agent 106, generated based on a prompt 114. In an example, the prompt 114 may be a system prompt. The prompt 114 may be a set of instructions or guidelines that provide context and direction to the AI agent 106 on how to interpret the user query and generate the automated response (interchangeably referred to as AI-generated response). The prompt 114 may include one or more directives related to the structure, tone, depth, and content of the automated response, depending on the specific requirements of the user query. The automated response may be an answer to the user query or a solution to the problem, generated by the AI agent 106 using training data and the prompt 114. The validated response may refer to a response that has been verified or confirmed as accurate, reliable, and/or relevant to the user query. The validated response may be obtained as a result of a human-in-the-loop process. In an example, the validated response may be provided by as a human expert administrator based on the automated response.

In many additional embodiments, the adaptive learning system 102 may generate an input analysis prompt based on the one or more input parameters. The input analysis prompt may facilitate the review of the one or more input parameters. The adaptive learning system 102 may provide the one or more input parameters and the input analysis prompt as a first input to the first large language model 110A. The first large language model 110A may review and analyze the one or more input parameters based on the input analysis prompt and generate an analysis report. The first large language model 110A may then provide the analysis report to the adaptive learning system 102.

In many additional embodiments, the adaptive learning system 102 may receive the analysis report from the first large language model 110A based on the first input. In a non-limiting example, the analysis report may include at least one of the following: a result of a comparison between the automated response and the validated response, an identification of one or more output divergences between the automated response and the validated response, or at least one factor contributing to the one or more output divergences. In one example, an output divergence may occur when the automated response generated by the AI agent 106 is incomplete. A contributing factor to the output divergence may be that the AI agent 106 may not have been trained on a sufficiently comprehensive dataset that includes details to generate a complete response. In another example, an output divergence may occur when the automated response generated by the AI agent 106 is inaccurate, and a contributing factor to the output divergence may be that the AI agent 106 may have been trained with incorrect data and/or insufficient data.

In still further embodiments, the adaptive learning system 102 may provide, as a second input, the one or more input parameters, and the analysis report to one of the first large language model 110A or the second large language model 110B. The first large language model 110A or the second large language model 110B may review the one or more input parameters and the analysis report, and generate a learned memory 116. In still additional embodiments, one of the first large language model 110A or the second large language model 110B may provide the learned memory 116 to the adaptive learning system 102. In examples, the learned memory 116 may refer to a memory generated and refined after the analysis of input parameters, including automated and validated responses, as well as any identified divergences or discrepancies between the automated response and the validated response.

In yet several embodiments, the adaptive learning system 102 may receive the learned memory 116 from one of the first large language model 110A or the second large language model 110B based on the second input. In yet further embodiments, the adaptive learning system 102 may generate an updated prompt by injecting the learned memory 116 into the prompt 114. In an example, the updated prompt may be a system prompt. In still yet further embodiments, the adaptive learning system 102 may validate the learned memory 116. To validate the learned memory 116, the adaptive learning system 102 may provide the user query and the updated prompt to the AI agent 106. The AI agent 106 may generate an updated automated response for the user query based on the updated prompt. The AI agent 106 may then provide the updated automated response to the adaptive learning system 102.

In yet additional embodiments, the adaptive learning system 102 may receive, in response to providing the user query and the updated prompt to the AI agent 106, the updated automated response from the AI agent 106 for the user query. In still yet additional embodiments, the adaptive learning system 102 may compare the updated automated response with the validated response using one of the first large language model 110A, the second large language model 110B, or the third large language model 110C. In an embodiment, the updated automated response may be compared with the validated response based on analyzing differences/divergences or similarities between the updated automated response and the validated response

The adaptive learning system 102 may receive, based on the comparison, an indication that the learned memory 116 has been successfully validated from one of the first large language model 110A, the second large language model 110B, or the third large language model 110C. in examples, if the updated automated response is accurate and consistent with the validated response, the adaptive learning system 102 may receive the indication that the learned memory 116 has been successfully validated. The adaptive learning system 102 may store at least one of the learned memory 116 or the updated prompt in the database 112 based on the received indication. In an embodiment, the learned memory 116 may be associated with a configured time period. The adaptive learning system 102 may delete the stored learned memory 116 from the database 112 upon the expiration of the configured time period.

In numerous additional embodiments, the adaptive learning system 102, based on the indication that the learned memory 116 has been successfully validated, may be further configured to create a plurality of variations of the user query. Further, the adaptive learning system 102 may encode at least one variation from the plurality of variations into an embedding vector. Subsequently, the adaptive learning system 102 may map the learned memory 116 to the embedding vector and store at least one of the learned memory 116 or the embedding vector in the database 112.

In further additional embodiments, the adaptive learning system 102 can also receive, based on the comparison, an indication that the validation of the learned memory has failed from one of the first large language model 110A, the second large language model 110B, or the third large language model 110C. In an example, if it is identified that the updated automated response diverges from the validated response by more than a threshold value, the adaptive learning system 102 may receive the indication that the validation of the learned memory has failed. In response to the indication that the validation of the learned memory has failed, the adaptive learning system 102 may re-learn a new learned memory using at least one of the first large language model 110A or the second large language model 110B. In an example, the re-learning of the new learned memory may be based on at least one of the updated automated response, the validated response, or the user query.

During the implementation phase (after a learned memory is created), the adaptive learning system 102 may receive a user query. The user query may be a new query. Upon receiving the new user query, the adaptive learning system 102 may encode the new user query into an embedding vector. The adaptive learning system 102 may then identify, from one or more historical user queries stored in a database (such as the database 112), a historical user query that has a similarity score with the embedding vector exceeding a threshold score. In many additional embodiments, the adaptive learning system 102 may retrieve a learned memory mapped to the identified historical user query from the database. The adaptive learning system 102 may generate an updated prompt by injecting the retrieved learned memory into a prompt associated with the new user query. The adaptive learning system 102 may receive a response to the new user query based on the updated prompt.

In yet additional embodiments, the adaptive learning system 102 may provide, as input, the user query and the updated prompt to an AI agent (such as AI agent 106). The adaptive learning system 102 may receive the response as output from the AI agent based on the provided input. The adaptive learning system 102 may validate the received response. In some embodiments, the result of the validation may include either a first indication of acceptance of the received response or a second indication of rejection of the received response.

In several additional embodiments, the adaptive learning system 102 may provide an advanced and efficient approach for continuously or iteratively improving the responses generated by the AI agent 106 within the distributed network architecture 100. The adaptive learning system 102 may incorporate multiple phases, such as the learning phase and the implementation phase, and leverage a combination of large language models (including the first large language model 110A, the second large language model 110B, and the third large language model 110C), learned memories, and real-time validation processes to generate contextually relevant responses. By utilizing a feedback loop in which learned memories are validated and refined over time, the adaptive learning system 102 may enhance future interactions, thereby offering valuable improvements across a wide range of industries and applications.

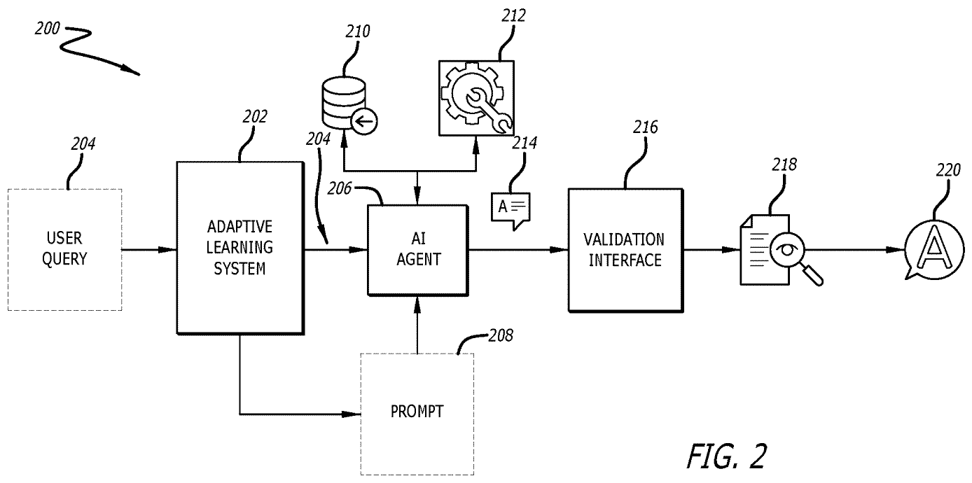

Although a specific embodiment for the distributed network architecture including the adaptive learning system that implements the adaptive learning framework for large language models suitable for carrying out the various steps, processes, methods, and operations described herein is discussed with respect to FIG. 1, any of a variety of systems and/or processes may be utilized in accordance with embodiments of the disclosure. For example, although it is described that an automated response is generated for a user query (provided by a user) by an AI agent, it may be understood that the response may also be generated based on an interaction between the user and the AI agent involving the user query. This interaction may include a sequence of conversational exchanges between the user and the AI agent. Further, in many embodiments, it has been described that a learned memory is injected into a system prompt. In alternative embodiments, the learned memory may be injected into a user prompt or any other type of prompt. The elements depicted in FIG. 1 may also be interchangeable with other elements of FIGS. 2-13 as required to realize a particularly desired embodiment.

Referring to FIG. 2, a schematic diagram 200 illustrates a process of generating a validated response 220 for a user query 204, in accordance with various embodiments of the disclosure. In an example, the user query 204 may represent a request from a user to obtain information, seek assistance, or perform a specific task. The validated response 220 may refer to a response that has been verified or confirmed as accurate, reliable, and/or relevant to the user query 204. As depicted in FIG. 2, the process of generating the validated response 220 for the user query 204 may leverage an adaptive learning system 202, an Artificial Intelligence (AI) agent 206, and a validation interface 216. In various embodiments, the adaptive learning system 202 may be equivalent to the adaptive learning system 102 and the AI agent 206 may be equivalent to the AI agent 106, both depicted in FIG. 1.

In various embodiments, the validation interface 216 may be a dashboard or an interface that allows a human expert to view user queries and the corresponding responses generated by the AI agent 206. A response generated by the AI agent 206 may be referred to as an AI-generated or automated response. In this context, the human expert may refer to an individual or group of individuals responsible for reviewing and validating the AI-generated responses to user queries. The human expert may have expertise in the domain relevant to the user queries and may be tasked with ensuring that the AI-generated responses are accurate, relevant, and appropriate for the specific domain.

In many embodiments, the validation interface 216 may be a component integrated into the human expert's device. In other embodiments, the validation interface 216 may be a cloud-based application accessible via a web browser. This allows the human expert to remotely review and validate AI-generated responses from any authorized device, offering flexibility and ensuring accessibility from various locations.

In a variety of embodiments, the adaptive learning system 202 may receive the user query 204 from a user, for example, via a user device. The user query 204 may be submitted in various formats, including text, voice, image, or other input formats. For example, the user query 204 may be a question such as, “What are the available options for exporting data from a system?”. The user query 204 can also be submitted as a customer support ticket, where the user requests help or clarification. For example, the user query 204 may be a request for assistance in resolving a login problem such as “I am unable to log into my account. Can you please help me reset my password?”. The user query 204 can further represent a request for a solution to a problem, where the user may seek guidance or assistance in a specific domain, such as healthcare domain. For example, the user query 204 may be a request to seek medical advice or information, such as “What are the symptoms of the flu?”.

In a number of embodiments, upon receiving the user query 204, the adaptive learning system 202 may be configured to generate a prompt 208. For example, the adaptive learning system 202 may be configured to generate a system prompt or a different type of prompt. A prompt may refer to a set of guidelines for an AI agent that defines behavior, tone, and response style. The prompt may assist the AI agent in interpreting user queries, retrieving relevant information, and generating responses. In examples, the prompt 208 may include one or more of a generic element or a domain-specific element. The generic element may refer to a component of the prompt 208 that provides a standard instruction for generating a response to the user query 204. A generic element enables an AI agent to respond in a structured, comprehensive, and relevant manner across different types of user queries, regardless of domains to which the user queries belong. The domain-specific element may refer to a component of the prompt 208 that provides context-specific instruction for generating a response to the user query 204 within a particular domain. A domain-specific element enables an AI agent to tailor responses in accordance with specific context or requirements of user queries.

A non-limiting example, the prompt 208 may include “A user query has been received from a user. Provide a well-structured, detailed, and relevant response to address the user's request. The user is asking about the options for exporting data from a system. Provide a list of common export methods, depending on typical capabilities of the system in the relevant domain”. In this prompt 208, the phrase “A user query has been received. Provide a well-structured, detailed, and relevant response to address the user's request” may correspond to the generic element, while the phrase “The user is asking about the options for exporting data from a system. Provide a list of common export methods, depending on typical capabilities of the system in the relevant domain” may correspond to the domain-specific element.

In many more embodiments, the adaptive learning system 202 may provide the user query 204 and the prompt 208 to the AI agent 206. The AI agent 206 may process the user query 204 based on the prompt 208, using a vector database 210 and one or more tools 212. The vector database 210 may store data, including vectors and other associated items. Vectors are mathematical representations of data in a high-dimensional space, where each dimension corresponds to a specific feature or characteristic of the data. The number of dimensions in this space can range from a few hundred to tens of thousands, depending on the complexity of the data being represented. The position of a vector within this space reflects its characteristics. In various examples, different types of data such as words, phrases, entire documents, images, audio, and other forms of unstructured data can be converted into vectors and stored in the vector database 210. In examples, the vector database 210 may store vectors that represent various data items, including but not limited to documents, images, audio, or other types of unstructured data. In some examples, the vector database 210 may store vectors that represent historical user queries and corresponding responses. Further, the one or more tools 212 may assist the AI agent 206 in retrieving relevant information, performing searches, or applying domain-specific knowledge to generate an automated response 214 to the user query 204. Examples of the one or more tools 212 may include, but are not limited to, internal and external search tools (e.g., search engines, an organization's internal knowledge base, or public knowledge repositories), site content retrieval tools (e.g., product information webpages or troubleshooting forums), and domain-specific tools (e.g., legal document databases, financial analysis tools, or healthcare-related databases).

In yet various embodiments, upon receiving the user query 204 and the prompt 208, the AI agent 206 may initiate the processing of the user query 204. The AI agent 206 may encode the user query 204 into an embedding vector (also referred to as a query vector). This query vector may represent the semantic meaning of the user query 204 in a high-dimensional space, capturing the user's intent, such as finding export options for a system. For example, the AI agent 206 may convert the user query 204 into the query vector using an embedding model (for example, any known embedding model). The AI agent 206 may trigger a semantic search in the vector database 210. In numerous embodiments, the AI agent 206 may send a query to the vector database 210 to perform the semantic search. The vector database 210 may perform the semantic search based on a comparison of the query vector with stored vectors. The vector database 210 may perform the semantic search using a similarity metric (for example, any known similarity metric). The vector database 210 may return a list of matching vectors, similarity scores corresponding to the matching vectors, and/or text mapped to the matching vectors to the AI agent 206. In an example, the list of matching vectors may be returned in one or more documents. In many embodiments, a system administrator may define a similarity threshold, above which returned one or more documents may be accepted.

In a variety of embodiments, the AI agent 206 may identify one or more relevant vectors from the vectors stored in the vector database 210 (for example, the list of matching vectors) that closely match the query vector. In one embodiment, the AI agent 206 may identify these relevant vectors based on determining which stored vectors have a similarity score exceeding a predefined threshold score when compared to the query vector. The threshold score indicates that vectors with similarity scores above the threshold may be highly relevant to the query vector. Conversely, vectors with similarity scores below the threshold are considered insufficiently relevant and may not be used in generating the automated response 214. This process allows the AI agent 206 to identify relevant information (e.g., past solutions, memories, text chunks, metadata) that match the user query 204, providing necessary context for generating the response. Other ways to identify the one or more vectors are possible and whilst not explicitly discussed, are contemplated herein. The AI agent 206 may then generate the automated response 214 based on the prompt 208 and in response to the user query 204.

For example, if the user query 204 is “What are the available options for exporting data from the system?”, the AI agent 206 may process the user query 204 to extract key phrases such as “available options,” “exporting data,” and “system.” The AI agent 206 may use the query vector (embedding vector) to query the vector database 210. The vector database 210 may include vectors representing various types of data (e.g., export methods, documentation, and knowledge base entries). The vector database 210 may include vectors for export-related information, such as data on Comma-Separated Values (CSV), JavaScript Object Notation (JSON), and other export methods relevant to different systems.

In more embodiments, the AI agent 206 may query the vector database 210 to identify vectors that are semantically similar to the user query 204. The AI agent 206 may also utilize one or more tools 212 to enhance the response generation. In one example, the automated response 214 generated by the AI agent 206 may be “The system supports various data export methods like CSV, Excel, XML, and JSON. The available methods depend on the system's settings.”

In yet more embodiments, the adaptive learning system 202 may provide both the user query 204 and the automated response 214 to the validation interface 216. A designated person (such as a human expert), responsible for reviewing and ensuring the quality of the automated response 214, may log into the validation interface 216 to assess the user query 204 and corresponding automated response 214. Leveraging his or her domain expertise, the human expert may evaluate whether the automated response 214 adequately addresses the user query 204. In some cases, the human expert may determine that the automated response 214 is both accurate and complete. In such a case, the human expert may accept the automated response 214 as is, thereby confirming its validity.

However, in other scenarios, the human expert (e.g., a human in the loop) may determine that the automated response 214 is either partially incorrect, incomplete, or lacks critical information required to fully address the user query 204. For example, the automated response 214 may omit essential details, present outdated information, or fail to incorporate relevant domain-specific nuances. In these cases, the human expert may take corrective actions, such as modifying, expanding, or refining the automated response 214 to include the necessary information. After reviewing and potentially modifying the automated response 214, the human expert may generate a review report 218. This review report 218 may include the updated or revised response, which is referred to as the validated response 220. A validated response may refer to a response that has been verified or confirmed as accurate, reliable, and relevant to a user query. In examples, the validated response 220 may be “Data export options typically include CSV, Excel, XML, JSON, and APIs. The specific options available are determined by the system's configuration and user permissions”. In yet many embodiments, the feedback loop created by the human expert's insights may enhance the performance of the adaptive learning system 202. When the human expert identifies missing, outdated, or incorrect information in the automated response 214, the human expert may modify, expand, or refine the automated response 214. These changes may introduce new critical information that may be used for future response generation. The validated response 220 may assist the adaptive learning system 202 to learn and store this critical information. Over time, the adaptive learning system 202 may become more adept at handling similar user queries without requiring additional oversight. This process may contribute to the adaptive learning system's continuous improvement, as the adaptive learning system 202 integrates new insights to enhance its future responses.

Although a specific embodiment for process of generating the validated response for the user query, suitable for carrying out the various steps, processes, methods, and operations described herein is discussed with respect to FIG. 2, any of a variety of systems and/or processes may be utilized in accordance with embodiments of the disclosure. For example, the human expert may not generate the review report and directly generate the validated response based on the user query and the automated response. The elements depicted in FIG. 2 may also be interchangeable with other elements of FIG. 1 and FIGS. 3-13 as required to realize a particularly desired embodiment.

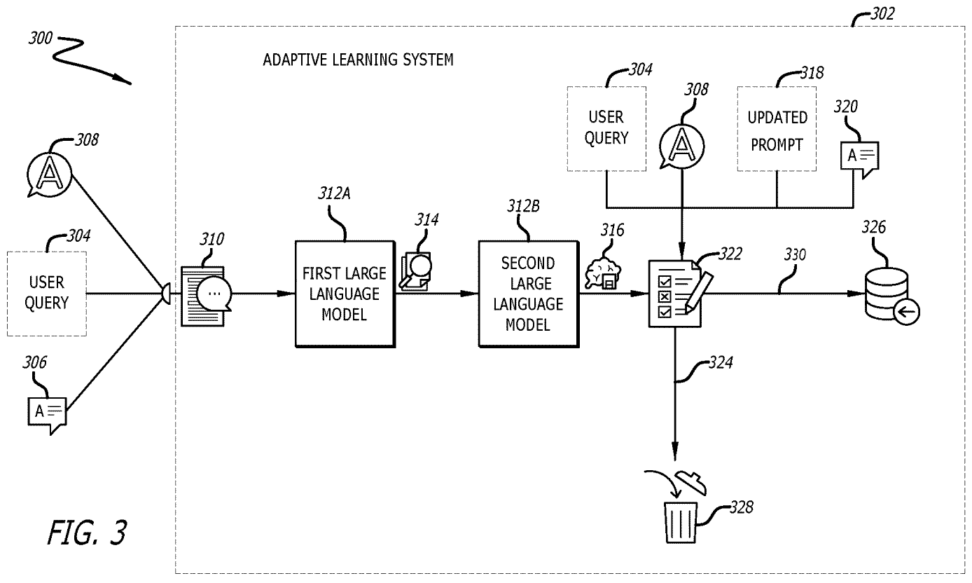

Referring to FIG. 3, a diagram 300 depicting a process for generation and validation of a learned memory 316 for an adaptive learning system 302 in accordance with various embodiments of the disclosure is shown. In many embodiments, the adaptive learning system 302 may include a first large language model 312A, a second large language model 312B, and a database 326. In a number of embodiments, the adaptive learning system 302 may be equivalent to the adaptive learning system 102 of FIG. 1 and the adaptive learning system 202 of FIG. 2, where the first large language model 312A corresponds to the first large language model 110A and the second large language model 312B corresponds to the second large language model 110B, and the database 326 corresponds to the database 112. In further embodiments, although the first large language model 312A and the second large language model 312B are shown as independent large language models in FIG. 3, tasks associated with both the first large language model 312A and the second large language model 312B may be performed by a single large language model (also referred to as a reasoning model). For example, the first large language model 312A and the second large language model 312B may be replaced with the single large language model.

In a variety of embodiments, the adaptive learning system 302 may receive one or more input parameters, which may include at least one of a user query 304, an automated response 306, or a validated response 308. The automated response 306 and the validated response 308 may be associated with the user query 304. In one example, the user query 304 may represent a request for information, assistance with a task, or completion of a specific action. In examples, the user query 304 may be a question or problem text provided by a user.

In various embodiments, the adaptive learning system 302 may receive the automated response 306 from an AI agent, based on a prompt, in response to the user query 304. The AI agent may be equivalent to the AI agent 106 of FIG. 1. Further, the prompt may be a set of instructions or guidelines that provide context and direction to the AI agent on how to interpret the user query 304 and generate the automated response 306. The prompt may include one or more directives related to the structure, tone, depth, and content of the automated response 306, depending on the specific requirements of the user query 304. The automated response 306 may be an answer to the user query 304 or solution to the problem provided by the AI agent using its training data and the prompt. Furthermore, the validated response 308 may refer to a response (answer to the user query 304 or a solution to the user query 304) that has been verified or confirmed as accurate, reliable, and/or relevant to the user query 304. In yet various embodiments, the validated response 308 may be generated by one or more human experts based on the automated response 306. The validated response 308 may be generated through a process in which the automated response 306 is reviewed and evaluated for accuracy, relevance, and reliability by the one or more human experts. In an example, the user query 304 may be “What are the available options for exporting data from a system?”, the automated response 306 may be “The system supports various data export methods like CSV, Excel, XML, and JSON. The available methods depend on the system's settings”, and the validated response 308 may be “Data export options typically include CSV, Excel, XML, JSON, and APIs. The specific options available are determined by the system's configuration and user permissions”.

In further embodiments, the adaptive learning system 302 may be configured to generate an input analysis prompt 310 based on the one or more input parameters. The input analysis prompt 310 may be a set of instructions or guidelines that provide context and direction on how to review and analyze the one or more input parameters. In examples, the input analysis prompt 310 may include specific instructions or guidelines on how to analyze the automated response 306 and the validated response 308 based on the user query 304.

In additional embodiments, the adaptive learning system 302 may provide, as a first input, the one or more input parameters and the input analysis prompt 310 to the first large language model 312A. The first large language model 312A may generate an analysis report 314 based on the first input, e.g., the one or more input parameters and the input analysis prompt 310. In a non-limiting example, the analysis report 314 may include at least one of a result of a comparison between the automated response 306 and the validated response 308, an identification of one or more output divergences in the automated response 306 compared to the validated response 308, or at least one factor for the one or more output divergences. Considering the above examples of the user query 304, the automated response 306, and the validated response 308, an output divergence in the automated response 306 compared to the validated response 308 may be that the automated response 306 lacks clarity regarding the conditions under which data export options are available, while the validated response 308 specifies that the availability of export options depends on system configuration and user permissions. Further, a factor for output divergence may be non-inclusion of conditional context (for example, system configuration and user permissions) in the automated response 306, which is required for understanding when or how data export options are available. The validated response 308 may include this required detail, making the validated response 308 more precise and informative. Another example of output divergence in the automated response 306 compared to the validated response 308 may be that the automated response 306 mentions “various data export methods like CSV, Excel, XML, and JSON,” but does not mention APIs as an option. A factor for output divergence may be incomplete listing of export options in the automated response 306, which omits “APIs,” which is a common export method.

In several embodiments, the adaptive learning system 302 may receive the analysis report 314 from the first large language model 312A based on the first input. The adaptive learning system 302 may then provide, as a second input, the one or more input parameters and the analysis report 314 to the second large language model 312B. The second large language model 312B may generate a learned memory 316 based on the second input, comprising the one or more input parameters and the analysis report 314. In some examples, the second large language model 312B may review the technical insights associated with the analysis report 314 and generate the learned memory 316 accordingly. For instance, the learned memory 316 may include information regarding the conditional context to be incorporated in responses when discussing available export options. Additionally, the learned memory 316 may clarify that the availability of data export methods (e.g., CSV, Excel, XML, JSON, and APIs) depends on the system's configuration settings and user permissions. Furthermore, the learned memory 316 may ensure that all relevant export methods, including APIs, are explicitly mentioned in the response. As such, the learned memory 316, derived from the analysis report 314, serves to address missing contextual details (e.g., system configuration and user permissions) and guarantees completeness by incorporating all relevant export methods (such as APIs).

In several more embodiments, the adaptive learning system 302 may receive the learned memory 316 from the second large language model 312B based on the second input. The adaptive learning system 302 may then generate an updated prompt 318 through memory injection of the learned memory 316 into the prompt. The learned memory 316 when injected into the prompt, may guide an AI agent in generating more accurate, contextually appropriate, and complete response in the future. In an example, the prompt may be “A user query has been received from a user. Provide a well-structured, detailed, and relevant response to address the user's request. The user is asking about the options for exporting data from a system. Provide a list of common export methods, depending on typical capabilities of the system in the relevant domain”, and the updated prompt 318 may be “When responding to a user query about data export options, include information about the conditions under which certain export methods are available. Mention that condition context that determine which data export methods can be used. Always include all possible data export methods including APIs, ensuring clarity and completeness in the response”. Although it has been described that the adaptive learning system 302 provides the one or more input parameters and the analysis report 314 to the second large language model 312B, in various embodiments, the adaptive learning system 302 may provide the one or more input parameters and the analysis report 314 to the first large language model 312A. In various further embodiments, the first large language model 312A may generate the learned memory 316 based on the one or more input parameters and the analysis report 314, and provide the learned memory 316 to the adaptive learning system 302.

In numerous embodiments, the adaptive learning system 302 may be configured to validate the learned memory 316. To validate the learned memory 316, the adaptive learning system 302 may be configured to provide one or more of the user query 304 and the updated prompt 318 to the AI Agent. The AI agent may generate an updated automated response 320 for the user query 304 based on the updated prompt 318. In numerous additional embodiments, the adaptive learning system 302 may receive, in response to providing the user query 304 and the updated prompt 318 to the AI agent, the updated automated response 320 from the AI agent for the user query 304.

In additional embodiments, the adaptive learning system 302 may be configured to compare the updated automated response 320 with the validated response 308 using one of the first large language model 312A, the second large language model 312B, or a third large language model (which may be equivalent to the third large language model 110C of FIG. 1). The adaptive learning system 302 may provide the user query 304, the validated response 308, the updated prompt 318, and the updated automated response 320 to one of the first large language model 312A, the second large language model 312B, or the third large language model. The first large language model 312A, the second large language model 312B, or a third large language model may perform a comparison between the updated automated response 320 and the validated response 308 and generate a comparison report 322. The comparison report 322 may include the results of the comparison between the updated automated response 320 and the validated response 308. In some embodiments, if the comparison report 322 indicates that there is no divergence between the updated automated response 320 and the validated response 308, this may signify that the learned memory 316 has been successfully validated. In this case, the first large language model 312A, the second large language model 312B, or a third large language model may accept the updated automated response 320 without modification. However, if the comparison report 322 identifies one or more output divergences between the updated automated response 320 and the validated response 308, or highlights factors contributing to these divergences, it may indicate that the validation of the learned memory 316 has failed. In this scenario, the first large language model 312A, the second large language model 312B, or the third large language model may reject the updated automated response 320. In various embodiments, based on the results of the comparison, the first large language model 312A, the second large language model 312B, or the third large language model may generate a first indication 330 confirming the successful validation of the learned memory 316, or a second indication 324 indicating that the validation of the learned memory 316 has failed.

In still more embodiments, the adaptive learning system 302 may receive the first indication 330 from one of the first large language model 312A, the second large language model 312B, or the third large language model, indicating that the learned memory 316 has been successfully validated. Upon receiving the first indication 330, the adaptive learning system 302 may store at least one of the learned memory 316 or the updated prompt 318, which includes the learned memory 316, in the database 326. In an example, the database 326 may be implemented as a vector database. In yet more embodiments, the learned memory 316 may be stored within a domain-specific space corresponding to the domain of the user query 304, thereby facilitating efficient retrieval based on the domain context. Furthermore, the learned memory 316 may be associated with a configured time-period. After the expiration of the configured time-period, the adaptive learning system 302 may automatically delete the stored learned memory 316 from the database 326. This time-based expiration ensures that outdated learned memories are removed from the database 326, preventing them from being used in future interactions and ensuring the accuracy and relevance of the stored data. For example, the learned memory 316 may be configured to expire and be deleted after a period of 90 days, ensuring that any outdated or irrelevant memories are no longer accessible after that time, thereby maintaining the validity of the learned information.

In yet further embodiments, in response to the indication that the learned memory 316 has been successfully validated, the adaptive learning system 302 may further be configured to generate a plurality of variations of the user query 304. This process enhances the ability of the adaptive learning system 302 to accurately match similar user queries in the future, even if phrased differently. In an embodiment, the adaptive learning system 302 may encode one or more of the variations in the plurality of variations into an embedding vector. The adaptive learning system 302 may then map the learned memory 316 or the updated prompt 318, which includes the learned memory 316, to the generated embedding vector. Additionally, the adaptive learning system 302 may store, in the database 326, at least one of the following: the updated prompt 318 (including the learned memory 316), the learned memory 316 itself, and the embedding vector.

In a non-limiting example, the plurality of variations of the user query 304 may include variations such as “How can I export data from the system?”, “What are the different ways to export data from the system?”, “How do I export system data to a file?”, “How do I export data from the platform?”, and “How can I transfer data from the system?”. Each of these variations captures a different phrasing or perspective of the original user query 304 thereby improving the ability of the adaptive learning system 302 to match these variations with future queries posed by users. These variations may be encoded into embedding vectors and mapped to the learned memory 316 for use in future interactions.

In contrast, if the adaptive learning system 302 receives the second indication 324 from one of the first large language model 312A, the second large language model 312B, or the third large language model, indicating that the validation of the learned memory 316 has failed, the adaptive learning system 302 may be configured to discard the learned memory 316. In an example, upon receiving the second indication 324, an operation 328 may be triggered. According to the operation 328, the adaptive learning system 302 may discard the learned memory 316 because validation of the learned memory 316 failed. Furthermore, in response to the failed validation, the adaptive learning system 302 may be configured to re-learn a new learned memory based on at least one of the updated automated response 320, the validated response 308, or the user query 304. The re-learning process may be performed by at least one of the first large language model 312A or the second large language model 312B.

Although a specific embodiment of the process for generating and validating the learned memory for the adaptive learning system 302, suitable for carrying out the various steps, processes, methods, and operations described herein is discussed with respect to FIG. 3, any of a variety of systems and/or processes may be utilized in accordance with embodiments of the disclosure. For example, the adaptive learning system 302 may support generation of a plurality learned memories that may be validated and stored in the database 326. This may enable an AI agent to provide a full correct response to future user queries without needing the manual intervention to modify/edit its answers. The elements depicted in FIG. 3 may also be interchangeable with other elements of FIGS. 1-2 and FIGS. 4-13 as required to realize a particularly desired embodiment.

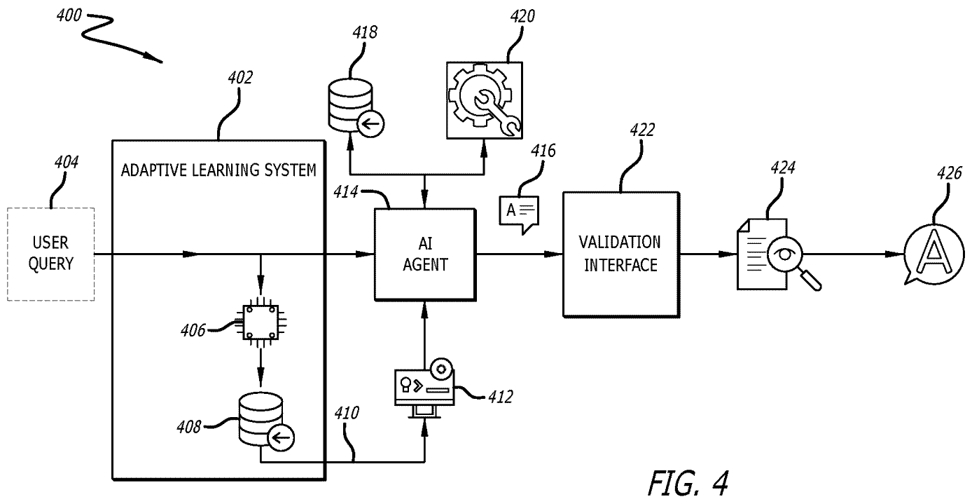

Referring to FIG. 4, a diagram 400 depicting a process of generating an updated prompt 412 through memory injection of a retrieved learned memory into a prompt for an AI agent 414 in accordance with various embodiments of the disclosure is shown. As depicted in FIG. 4, the process of generating the updated prompt 412 through memory injection of the retrieved learned memory into the prompt may leverage an adaptive learning system 402, an AI agent 414, and a validation interface 422. In numerous scenarios, the validation interface 422 may be optional. In various embodiments, the adaptive learning system 402 may be equivalent to the adaptive learning system 102 of FIG. 1, the adaptive learning system 202 of FIG. 2, and the adaptive learning system 302 of FIG. 3. Further, the AI agent 414 may be equivalent to the AI agent 106 of FIG. 1 and the AI agent 206 of FIG. 2. Furthermore, the validation interface 422 may be equivalent to the validation interface 216 of FIG. 2.

In various embodiments, the adaptive learning system 402 may receive a user query 404 from a user via a user device. For example, the user query 404 may be “How can I export data from a system?”. Upon receiving the user query 404, the adaptive learning system 402 may encode the user query 404 into an embedding vector using an embedding model 406 (for instance, any known embedding model). Subsequently, the adaptive learning system 402 may query a database 408 that includes one or more historical user queries.

In many embodiments, the adaptive learning system 402 may perform a similarity search within the database 408 to identify, from the one or more historical user queries, a historical user query that has a similarity score exceeding a threshold score when compared to the embedding vector of the user query 404. For example, the identified historical user query may be “How do I export data from the platform?”. The similarity score of the identified historical user query may be 0.88, while the threshold score may be set at 0.85. Since the similarity score of the identified historical user query exceeds the threshold score, the identified historical user query is deemed sufficiently similar to the user query 404. Upon identifying the relevant historical user query, the adaptive learning system 402 may retrieve a learned memory 410 that is mapped to the identified historical user query.

In a variety of embodiments, the adaptive learning system 402 may generate an updated prompt 412 by injecting the retrieved learned memory 410 into a prompt. The adaptive learning system 402 may then provide the updated prompt 412, along with the user query 404, as input to the AI agent 414. The AI agent 414 may generate an automated response 416 for the user query 404 based on the updated prompt 412, utilizing a database 418 and one or more tools 420 to generate the automated response 416. The adaptive learning system 402 may then receive the response 416 from the AI agent 414. Following the generation of the response 416, the adaptive learning system 402 may optionally validate the response 416 using a validation interface 422, and generate a result 424. The result 424 may include a first indication 426, indicating that the response 416 has been accepted, or a second indication, indicating that the response 416 has been rejected.

In yet many embodiments, the integration or injection of learned memory into the prompt significantly improves the capacity of the adaptive learning system 402 to produce accurate and contextually relevant responses. By utilizing historical queries and learned memories, the adaptive learning system 402 ensures that the generated responses accurate and aligned with the user's intent. Further, ongoing validation and refinement of the learned memory optimize subsequent interactions, ensuring continued adaptability of the adaptive learning system 402 and enhancing the overall quality of responses.

In further embodiments, the adaptive learning system 402 may employ re-ranking techniques to enhance the retrieval of relevant user queries. The adaptive learning system 402 may use a large language model to re-rank the historical user queries based on the user query 404 as context. In furthermore embodiments, the adaptive learning system 402 may use a reranking model to re-rank the historical user queries based on the user query 404.

In several embodiments, the large language model may modify the similarity scores of historical user queries by considering contextual factors from the user query 404, such as its phrasing, intent, or domain-specific nuances. For example, the large language model may adjust the similarity score by factoring in new information derived from the updated context, enabling the adaptive learning system 402 to refine the query retrieval process. This dynamic re-ranking approach ensures that the adaptive learning system 402 continues to optimize the relevance and quality of responses to user queries.

Although a specific embodiment of the process of generating the updated prompt through memory injection of the retrieved learned memory into the prompt for the AI agent, suitable for carrying out the various steps, processes, methods, and operations described herein is discussed with respect to FIG. 4, any of a variety of systems and/or processes may be utilized in accordance with embodiments of the disclosure. For example, the adaptive learning system 302 may render the validated response on a user device as an output for the received user query. The elements depicted in FIG. 4 may also be interchangeable with other elements of FIGS. 1-3 and FIGS. 5-13 as required to realize a particularly desired embodiment.

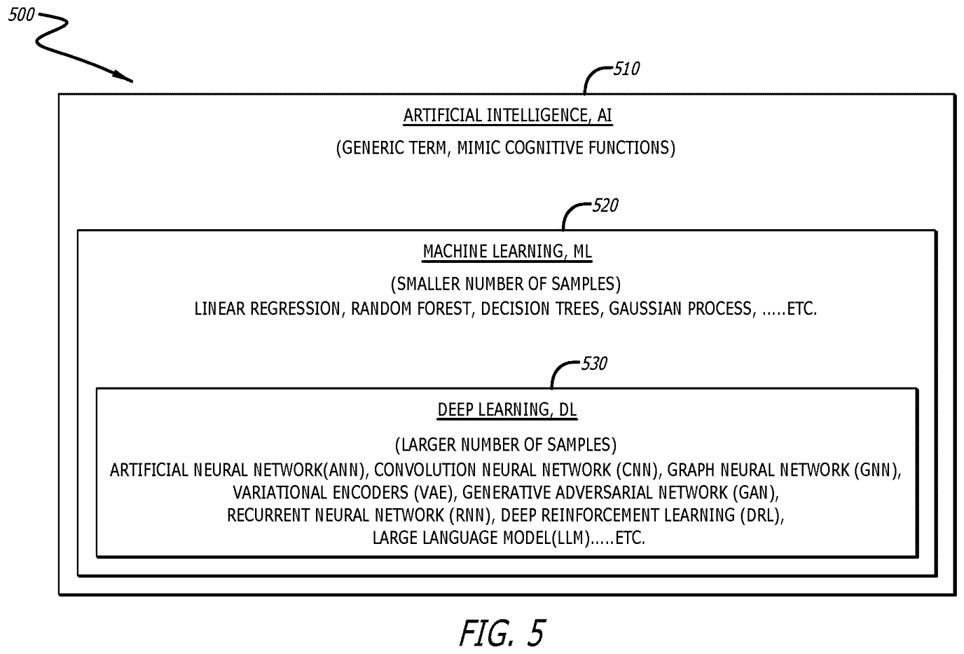

Referring to FIG. 5, a diagram 500 depicting various subsets of artificial intelligence in accordance with various embodiments of the disclosure is shown. Artificial intelligence (AI) 510 is typically understood in the art to be the development of machines and algorithms that mimic human intelligence, for example, by optimizing actions to achieve certain goals. At its core, AI 510 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions. AI 510 may be utilized to operate as an AI agent for executing automated tasks.

AI 510 can be considered a generic term because it encompasses a wide range of subfields and techniques, from simple rule-based systems to advanced machine learning and deep learning models. These AI techniques are used to simulate various aspects of human cognition. For example, machine learning (ML) 520 allows computers to learn from data patterns without explicit programming for each task, while natural language processing (NLP) enables machines to understand and generate human language. Deep learning (DL) 530, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems (e.g., AI agents) that can function autonomously and intelligently in real-world scenarios. As AI 510 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 520 is a subset of Artificial Intelligence (AI) 510 that focuses on the development of algorithms and statistical models that enable computers (e.g., executing AI agents) to learn and make decisions from data without explicit programming. In traditional programming, a computer is given a fixed set of rules to follow, but ML 520 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to autonomously interpret, bid for, and execute tasks within a distributed system. These methods leverage learned memories and decision-making capabilities to provide accurate, reliable, and relevant responses to user queries without the need for manual intervention.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 520. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical user queries, corresponding responses, and feedback from human expert(s).

However, traditional ML methods rely heavily on feature engineering, wherein human experts manually identify the most relevant features or patterns within the data. For example, when using ML 520 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 530 is a specialized subset of Machine Learning (ML) 520 that employs multi-layered artificial neural networks to automatically learn complex patterns and representations from large, often unstructured datasets. Inspired by the way the human brain processes information, DL 530 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 530 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 520 neural network designed to work particularly well with image data, making them highly relevant AI agents for user queries related to image data. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the important information. After several layers of convolutions and pooling, the CNN can output a task execution result, for example, classifying an image or generating a score suitable for evaluation for an image.

While CNNs are well-suited for grid-based data like images, many real-world problems can involve non-grid data, such as user queries. This type of data may better be represented as a graph, where nodes represent words and phrases in a user query and edges represent relationships between the words and the phrases. Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is important in predicting properties that depend on the current/local structure, such as the behavior of a network node.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to apply a learned memory, when generating a response to a user query, or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to detect vulnerabilities in a system such as communication network.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as network configurations or complex network simulations.

An AI agent leveraging DRL can be utilized in various scenarios requiring optimal decision making. For example, optimizing traffic routing policies or finding an optimal network path with reduced latency. The combination of RL and DL can allow for learning from raw data, making it a powerful tool for dynamic and real-time decision-making across a wide range of applications.

A Large Language Model (LLM) may be a specialized subset of Deep Learning (DL) 530 that utilizes deep neural networks to process and generate responses to user queries. The LLM may be specifically designed to understand, generate, and interact with human language in a natural and contextually relevant manner. The LLM is an advanced neural network designed to process and generate textual data. The LLM may be built upon transformer architectures, such as the Transformer model or variants, which enable the model to efficiently capture long-range dependencies, contextual relationships, and syntactic structures within the input language. Through training on vast corpora of diverse and extensive text datasets, the LLM learns to represent and process complex linguistic patterns, allowing it to generate coherent, contextually appropriate, and highly relevant responses to a wide variety of user queries. This ability to model language at multiple levels of abstraction makes the LLM suitable for a wide range of applications, including, but not limited to, automated customer service, content generation, question answering systems, language translation, and conversational AI. Furthermore, the LLM can adapt to various domains and handle diverse forms of input data, such as written text, speech transcriptions, or even multimodal inputs, enhancing its utility in dynamic, real-time interactions and decision-making processes.

The transformer architecture may consist of multi-layer encoder-decoder blocks that enable the LLM to capture long-range dependencies, contextual relationships, and syntactic structures within the input language, including word sequences. The transformer architecture may employ various mechanisms to assess the significance of different words in a sequence, allowing the LLM to efficiently capture context. During training, a tokenizer can convert raw text into a format the LLM can process. Typically, the tokenizer may utilize methods such as Byte Pair Encoding (BPE) or SentencePiece, which break down text into subword units. This helps control vocabulary size and ensures that the LLM can handle rare or unknown words by splitting them into smaller, more frequent components. The batch size during training may vary based on computational resources, memory limitations, and model size. To optimize performance and efficiency, the LLM can utilize quantization techniques that reduce the precision of model weights. Quantization may enable faster inference and lower memory usage without significantly compromising accuracy. This makes quantized models particularly valuable for deployment in resource-constrained environments. The LLM can contain millions to billions of parameters, which allow the LLM to model complex language patterns effectively. As a result, the LLM can handle tasks such as text generation, translation, summarization, and more. The LLM may undergoe extensive training, with hyperparameters such as learning rate, optimizer choice, and the number of training epochs carefully adjusted to ensure peak performance.

Although a specific embodiment for a diagram 500 depicting various subsets of artificial intelligence suitable for carrying out the various steps, processes, methods, and operations described herein is discussed with respect to FIG. 5, any of a variety of systems and/or processes may be utilized in accordance with embodiments of the disclosure. For example, other subset may be present and available for use within AI 510. Those skilled in the art will recognize that the diagram 500 presented in FIG. 5 is simplified for illustration purposes and various methods and techniques may interact with other areas (ML 520 with DL 530, etc.). The elements depicted in FIG. 5 may also be interchangeable with other elements of FIGS. 1-4 and 6-13 as required to realize a particularly desired embodiment.

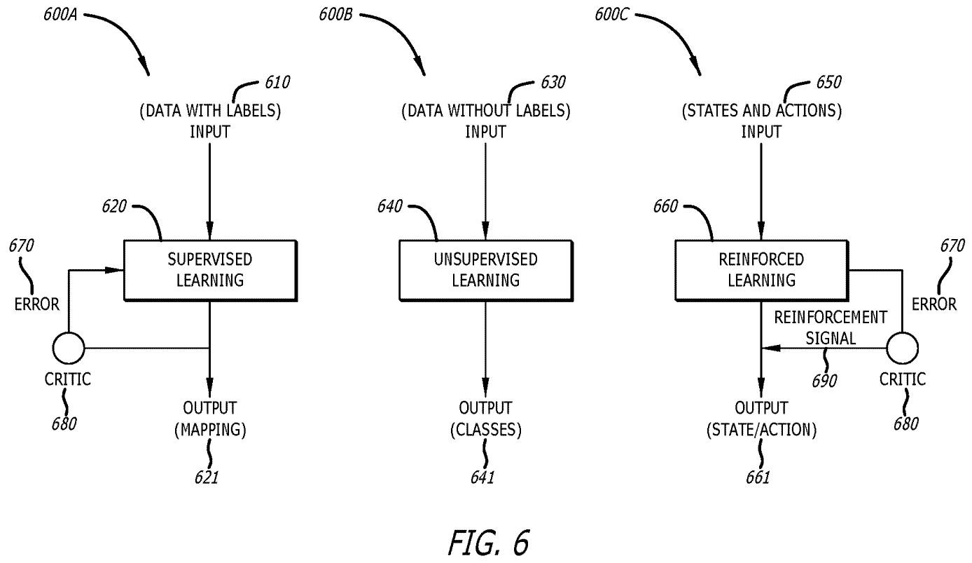

Referring to FIG. 6, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model (e.g., an AI agent) which can capture these patterns and make predictions on new data.

ML models can be understood as a device (e.g., an AI agent) that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 6, a supervised learning system 600A is shown. The supervised learning system 600A can be configured with a supervised learning model 620 that accepts input data 610 and generates an output 621. However, the output data is often reviewed by a critic 680 that can determine one or more errors 670 that are fed back into the supervised learning model 620 for use in updating.

Supervised learning systems 600A are often considered the simplest machine learning model to understand in which input data (such as training data) has a known label or result as an output. So, the supervised learning model 620 can be understood to work on the principle of input-output pairs. As such, a function can be trained using a training data set, which is then applied to unknown data and makes some predictive performance. Supervised learning is task-based and mostly tested on labeled data sets.

Supervised learning systems 600A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to a learned memory, for example, developing a comprehensive, prompt that enables an AI agent to generate an accurate automated response for a user query. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a response to a user query is accurate, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P (y|X) of that class given a particular predictor. P (y) is the prior probability of that class, P (X) is the prior probability of the predictor, and P (X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on a domain of a user query, AI-generated response to the user query, etc.

Again, in the embodiment depicted in FIG. 6, an unsupervised learning system 600B is shown. The unsupervised learning system 600B can be configured with an unsupervised learning model 640 that accepts input data 630 and generates an output 641. Unlike other model types, there are no critics or error signals to process. Unsupervised learning models 640 can implement the learning process opposite to supervised learning, which means it enables the model to learn from an unlabeled training dataset. Based on the unlabeled dataset, the unsupervised learning model 640 can predict the output. Using an unsupervised learning system 600B, the unsupervised learning model 640 can learn hidden patterns from the dataset by itself without any supervision. In various embodiments, unsupervised learning models 640 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate an accurate and reliable response for a user query based on a learned memory. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 6, a reinforcement learning system 600C is shown. The reinforcement learning system 600C can be configured with a reinforcement learning model 660 that accepts input data 650 and generates an output 661. In reinforcement learning, the reinforcement learning model 660 learns actions for a given set of states that lead to a goal state. In the embodiment depicted in FIG. 6, a critic 680 can receive or otherwise notice an error 670 within the reinforcement learning model 660 actions, and adjust the outcome/output by way of a reinforcement signal 690 such that the “reward” or “punishment” is adjusted to better model the future behaviors or processing of the reinforcement learning model 660.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 6, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 6 may also be interchangeable with other elements of FIGS. 1-5 and 7-13 as required to realize a particularly desired embodiment.

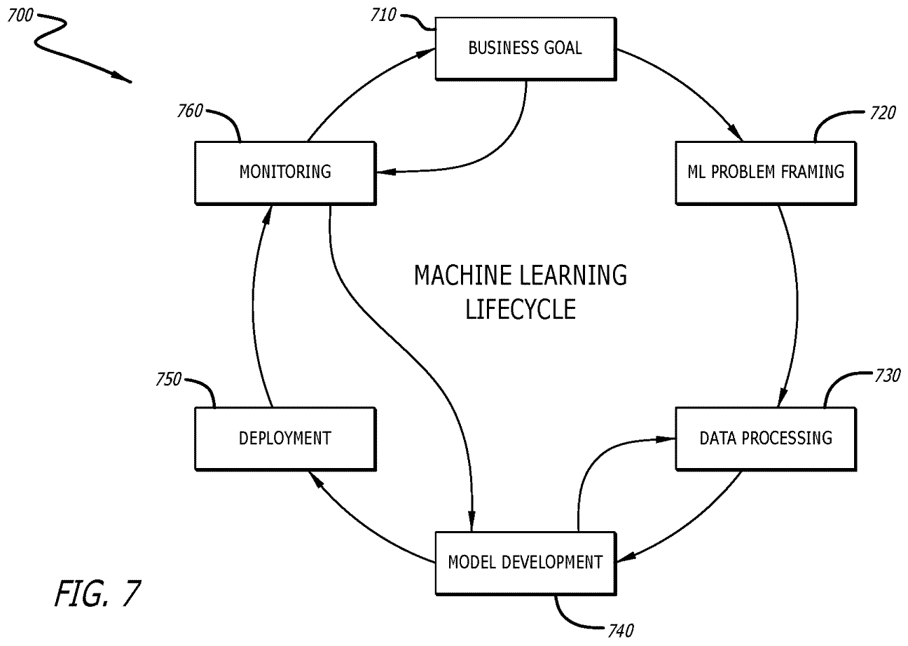

Referring to FIG. 7, a machine learning lifecycle 700 in accordance with various embodiments of the disclosure is shown. During the development of machine learning systems, the embodiment depicted in FIG. 7 can provide a framework for how to structure the design and maintenance of these systems. This machine learning lifecycle 700 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 700 emphasizes that developing a machine learning model is not a one-time effort but an iterative process requiring ongoing monitoring and adjustment. The feedback loop inherent in the machine learning lifecycle 700 allows for continual refinement and optimization of models to maintain their accuracy and relevance.

In many embodiments, a first stage of the machine learning lifecycle 700 is identifying the business goal 710, which sets the overall direction and purpose of the ML project. This can involve understanding the specific problems or opportunities within the business or project that machine learning can address. A clear business goal 710 ensures that the project remains focused on delivering tangible value, whether it is involves optimizing collaborative efforts in real-time operations, refining decision-making processes for dynamic environments, or autonomously adjusting to changing user queries. Without a well-defined goal, it can be challenging to align the subsequent stages of the ML lifecycle 700, as the choice of model, data processing methods, and performance metrics can all depend on what the business aims to achieve.

Establishing a proper business goal 710 can also involve engaging with key stakeholders and developers to gather requirements and set success criteria. It can provide a roadmap that outlines what success looks like and helps in framing the ML problem. For example, if the goal is to optimize response generation task execution, the project might focus on developing a predictive model that enables AI agents to interpret a user query, adapt to dynamic conditions, and generate a response to the user query with high accuracy. Clearly defined goals not only help guide the project but also provide benchmarks for evaluating the effectiveness of the deployed model once it enters production.

Once the business goal 710 is established, various embodiments take a next step involving ML problem framing 720, wherein the goal is translated into a specific machine learning task. This can involve selecting the appropriate type of ML problem, such as classification, regression, clustering, or recommendation, and defining the target variables or outputs. For example, if the goal is to optimize how AI agents generate responses to user queries in a distributed environment, the problem can be framed as a reinforcement learning task where the model predicts the likelihood of an AI-generated response being accepted based on its relevance to a user query. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 730 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 730 can require or at least benefit from careful planning and iterative refinement. Once the data is processed, it is typically split into training, validation, and test sets to develop and evaluate the model, ensuring that it generalizes well to new, unseen data.

Model development 740 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 740, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 730.

In further embodiments, deployment 750 is the stage where the developed model is integrated into the production environment to perform its intended tasks. This phase may involve setting up the necessary infrastructure, such as APIs or cloud-based services, to allow the model(s) to process live data and generate predictions. Deployment 750 can transform the model from a research tool into a functional component of a business process or product, providing real-time insights, automations, or decisions.

Proper deployment 750 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 710.

In more embodiments, monitoring 760 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 760, teams can identify when the model's performance drops and requires retraining or adjustments to align with the evolving data.

Monitoring 760 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 730 and model development 740, to refine the model(s) as needed. This iterative process allows the machine learning system to adapt and maintain its alignment with the original business goal 710 over time.

Although a specific embodiment for a machine learning lifecycle 700 suitable for carrying out the various steps, processes, methods, and operations described herein is discussed with respect to FIG. 7, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 7 may also be interchangeable with other elements of FIGS. 1-6 and 8-13 as required to realize a particularly desired embodiment.

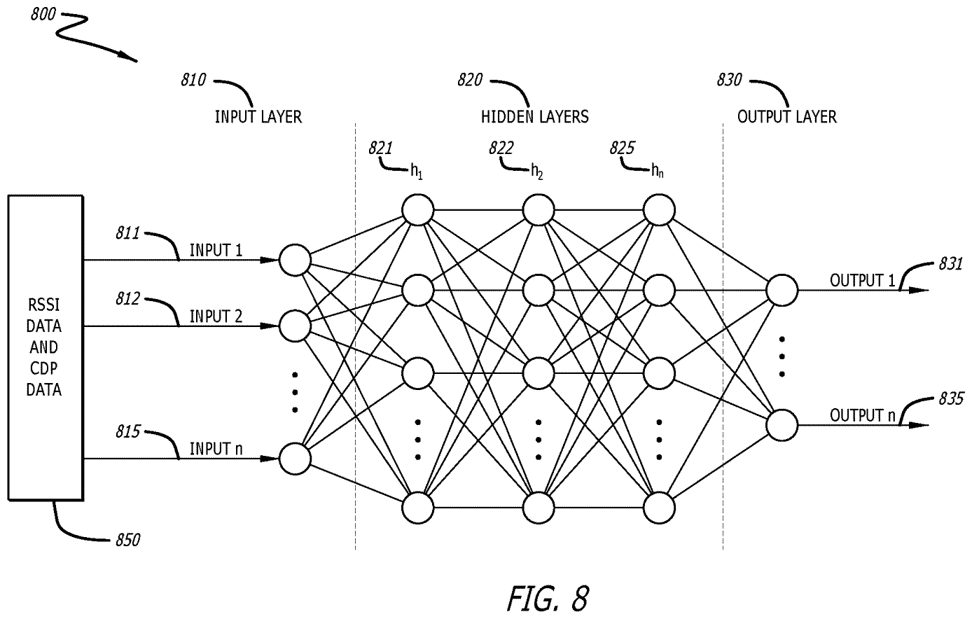

Referring to FIG. 8, an exemplary neural network 800 in accordance with various embodiments of the disclosure is shown. The embodiment depicted specifically depicts a feedforward neural network with multiple layers. This type of network consists of an input layer 810, one or more hidden layers 820, and an output layer 830. Each layer contains nodes (or neurons) that are interconnected, representing how data flows through the network. The input layer 810 can receive raw data, which is then processed by the hidden layers 820 through weighted connections and activation functions. These hidden layers 820 can enable the network to learn complex patterns and relationships within the data.

The final output layer 830 produces the network's predictions or classifications based on the processed input. The interconnected nature of the nodes allows the neural network 800 to learn from data during training by adjusting the weights of connections to minimize prediction errors. This structure is the foundation of deep learning models, as adding more hidden layers 820 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 800 depicted in the embodiment of FIG. 8, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 8 is presented as an exemplary ML solution that may be deployed within one or more methods or systems described herein.

In many embodiments, the input layer 810 is the first layer in a neural network 800 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 800 are generally scaled i.e., normalized to have a zero mean and/or unit standard deviation. Scaling can also be applied to the input of hidden layers (using batch or layer normalization) to improve the stability of neural network 800.

Unlike the hidden layers 820 and output layers 830, the input layer 810 typically does not perform any computations or transformations on the data. Its primary function is often to pass the input data to the next layer in the network, the first hidden layer 821. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 810 itself does not modify the data, it sets the stage for the neural network to extract complex patterns and relationships through the deeper layers. This flexibility in handling various types of input make the neural network 800 a powerful tool for a diverse set of applications.

With respect to the embodiments described herein, the input layer may be configured with a plurality of inputs providing historical user queries, AI-generated responses, and validated responses (shown as query data and response data 850). For example, a model can be configured with a first input 811 configured as first user query, a second input 812 is configured as a second user query, while additional inputs can be added related to the number of user queries received. The nth input 815 can be configured in certain embodiments to include nth user query. However, as those skilled in the art will recognize, additional setups can be configured such that the inputs can be configured to also include different parameters such as previous user queries, corresponding responses, and/or feedback from human experts.

In a number of embodiments, the neural network 800 comprises a plurality of hidden layers 820. The embodiment depicted in FIG. 8 comprises a first hidden layer 821, a second hidden layer 822, and an nth hidden layer 825, which are denoted as h₁, h₂, and hₙ respectively. In many embodiments, the hidden layers 820 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 821 h₁ receives direct input from the input layer, transforming the raw data into an initial set of features. For example, in an image recognition task, this layer might begin identifying basic patterns, such as edges or simple textures. The output of the first hidden layer 821 is then passed to a second hidden layer 822 h₂, which builds upon the features identified by the first hidden layer 821. This deeper layer might start recognizing more complex patterns, such as shapes or specific object components, by combining the lower-level features identified earlier. This can continue on until a last, nth hidden layer 825 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input 811 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 830 is often the final layer in a neural network and is responsible for producing the network's predictions or classifications based on the information processed through the previous hidden layers 820. Each neuron in the output layer 830 can represent a specific outcome or category that the model can predict. In the embodiment depicted in FIG. 8, the outputs are labeled as “output 1” 831 to “output n” 835, indicating that the network can be designed to have a varying number of outputs depending on the nature of the problem being solved. For example, in a binary classification task (e.g., choosing to accept or decline an AI-generated or automated response), there would typically be a single output neuron that provides a probability score for one of the two classes/outcomes. In contrast, for multi-class classification (e.g., selecting the most suitable action or strategy from several options), the output layer would contain multiple neurons, each corresponding to a different class.

The number of neurons in the output layer 830 can also designed specifically for other types of tasks, such as regression, where the model can predict continuous values. In such cases, the output layer 830 might contain a single neuron representing a numerical prediction, such as the price of a house or the temperature forecast, etc. Alternatively, in complex applications like multi-label classification (where each input can belong to multiple classes simultaneously), the output layer 830 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 800 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 8, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 8, which is an illustrative example meant to make it easier to explain the basic concepts of neural networks and how they process information. The specific features and functions described herein are not intended to be limiting to this specific embodiment. Additionally, the elements depicted in FIG. 8 may also be interchangeable with other elements of FIGS. 1-7 and 9-13 as required to realize a particularly desired embodiment.

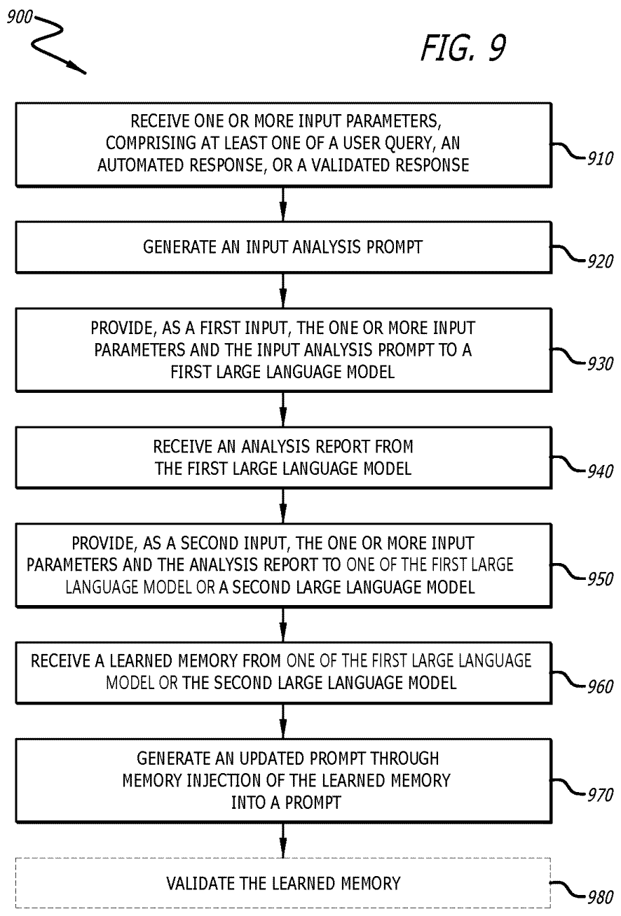

Referring to FIG. 9, a flowchart depicting a process 900 for generating an updated prompt through memory injection of a learned memory into a prompt in accordance with various embodiments of the disclosure is shown. In various embodiments, a prompt may be a set of instructions or guidelines that provide context and direction to an AI agent on how to interpret a user query and generate an appropriate response. The prompt may include one or more directives related to structure, tone, depth, and content of the response, depending on specific requirements of the user query. In an example, the user query may represent a request for information, assistance, or completion of a specific task, submitted by a user. In many embodiments, a learned memory may refer to information captured from past interactions between an AI agent and a user, and/or feedback received from a human expert, which the AI agent may use to enhance its performance in generating responses to user queries. The learned memory may be created through ongoing learning from historical data, user queries, and the results of past interactions, enabling the AI agent to adapt and refine its performance over time. Further, an AI agent may be a composite, autonomous software entity designed to generate responses to user queries. In various embodiments, the AI agent may operate based on an AI model that governs decision-making process of the AI agent, along with a set of tools that enable the AI agent to interpret the user queries and generate corresponding responses. Together, the AI model and tools allow the AI agent to understand the user queries and generate relevant responses.

In a variety of embodiments, the process 900 may receive one or more input parameters, including at least one of a user query, an automated response, or a validated response (block 910). The automated response and the validated response may be associated with the user query. In several embodiments, the process 900 may receive the user query from a user, via a user device. In examples, the user query may be a question or problem text provided by the user. In various embodiments, the process 900 may receive the automated response from an AI agent, based on a prompt, in response to the user query. The prompt may be a set of instructions or guidelines that provide context and direction to the AI agent on how to interpret the user query and generate the automated response. In examples, the automated response may be an answer to the user query or a solution to the problem provided by the AI agent using its training data and the prompt. The validated response may refer to a response (answer to the user query or a solution to the user query) that has been verified or confirmed as accurate, reliable, and/or relevant to the user query. In an example, the user query may be “How do I cancel my subscription?”, the automated response may be “You can cancel your subscription by visiting the ‘Billing’ section of your account settings.”, and the validated response may be “To cancel your subscription, go to the ‘Billing’ section in your account settings, select ‘Manage Subscriptions,’ and click on ‘Cancel Subscription.’ Follow the prompts to confirm your cancellation.”

In further embodiments, the process 900 may generate an input analysis prompt (block 920). In many examples, the input analysis prompt may include specific instructions or guidelines on how to analyze the automated response and the validated response based on the user query. In some embodiments, the process 900 may generate the input analysis prompt based on the one or more input parameters. The input analysis prompt may be a set of instructions or guidelines that provide context and direction on how to review and analyze the one or more input parameters.

In more embodiments, the process 900 may provide, as a first input, the one or more input parameters and the input analysis prompt to a first large language model (block 930). In yet various embodiments, the process 900 may prompt the first large language model to review and analyze the one or more input parameters based on the first prompt. In examples, the process 900 may prompt the first large language model to review the automated response to identify any shortcomings and reasons for shortcomings in comparison to the validated response.

In further embodiments, the process 900 may receive an analysis report from the first large language model (block 940). The analysis report may include at least one of a result of a comparison between the automated response and the validated response, an identification of one or more output divergences in the automated response compared to the validated response, or at least one factor for the one or more output divergences. For the provided examples, an output divergence in the automated response compared to the validated response may be that the automated response omits the crucial step of selecting “Manage Subscriptions” which is necessary to reach the option to cancel the subscription. Further, a factor for the output divergence may be incomplete or insufficient detail. The validated response addresses this issue by including all the necessary steps and clarifications, ensuring the process is more accurate and comprehensive.

In additional embodiments, the process 900 may provide, as a second input, the one or more input parameters and the analysis report to one of the first large language model or a second large language model (block 950). In various embodiments, the process 900 may prompt one of the first large language model or the second large language model to review and analyze the one or more input parameters and the analysis report. In examples, the process 900 may prompt one of the first large language model or the second large language model to review technical insights associated with the analysis report. In an embodiment, one of the first large language model or the second large language model may generate a learned memory based on the analysis report.

In further embodiments, the process 900 may receive a learned memory from one of the first large language model or the second large language model (block 960). In examples, the learned memory may include information regarding inclusion of all critical steps, such as navigating to the “Manage Subscriptions” section and confirming the cancellation for a successful subscription cancellation process. As may be understood, the learned memory derived from the analysis report, may address incomplete or insufficient detail (such as step of selecting “Manage Subscriptions”).

In many further embodiments, the process 900 may generate an updated prompt through memory injection of the learned memory into a prompt (block 970). In examples, the learned memory when injected into the prompt, may guide the AI agent in generating more accurate, contextually appropriate, and complete response in the future. In an example, the prompt may be “A user query has been received asking about how to cancel a subscription. Provide a clear and concise response on how the user can cancel their subscription. Include the relevant section of the account settings where this option can be found. The updated prompt may be “A user query has been received asking about how to cancel a subscription. Guide the user to the “Billing” section, direct them to “Manage Subscriptions,” instruct them to click on “Cancel Subscription,” and remind them to follow the confirmation prompts. Ensure that the response is clear, complete, and easy to follow, so that the user understands every step needed for successful cancellation.”.

In many further embodiments, the process 900 may validate the learned memory (block 980). To validate the learned memory, the process 900 may provide the user query and the updated prompt to an AI agent, and receive, in response to providing the user query and the updated prompt to the AI agent, an updated automated response from the AI agent for the user query. The process 900 may further compare the updated automated response with the validated response using one of the first large language model, the second large language model, or a third large language model, and receive, based on the comparison, an indication that the learned memory is successfully validated or an indication that the validation of the learned memory has failed. In numerous embodiments, validating the learned memory may be optional.

Although a specific embodiment for the process 900 for generating the updated prompt through memory injection of the learned memory into the prompt suitable for carrying out the various steps, processes, methods, and operations described herein is discussed with respect to FIG. 9, any of a variety of systems and/or processes may be utilized in accordance with embodiments of the disclosure. For example, after validating the learned memory, the process 900 may store the learned memory in a database. In further embodiments, a single large language model (also referred to as a reasoning model) may perform the tasks associated with both the first large language model and the second large language models. For instance, the first large language model and the second large language model may be replaced by the single large language model. The elements depicted in FIG. 9 may also be interchangeable with other elements of FIGS. 1-8 and FIGS. 10-13 as required to realize a particularly desired embodiment.

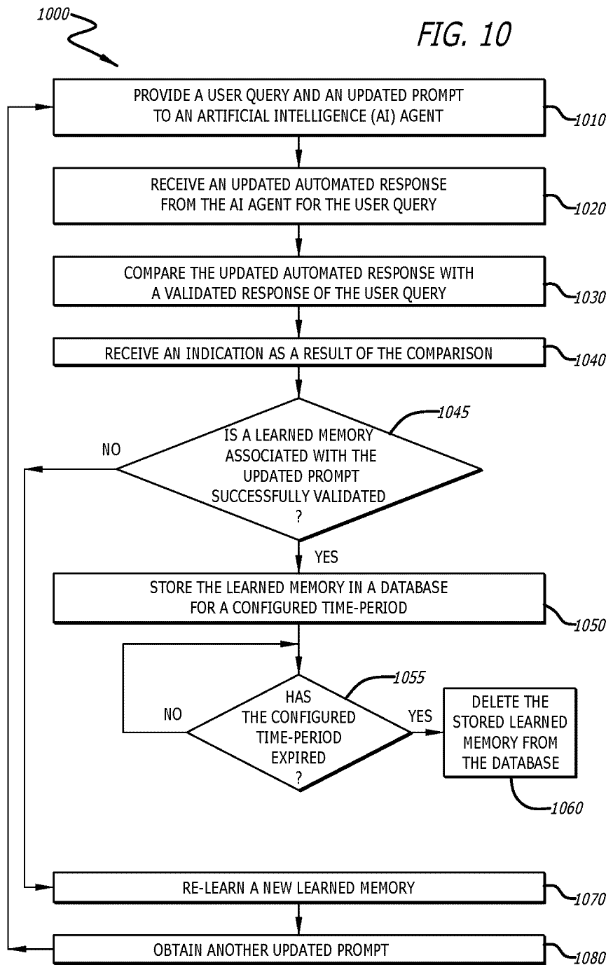

Referring to FIG. 10, a flowchart depicting a process 1000 for re-learning a new learned memory upon an unsuccessful validation of an existing learned memory in accordance with various embodiments of the disclosure shown. In an example, re-learning of a new learned memory refers to the process of generating a completely new learned memory when the existing learned memory does not meet validation criteria. If the existed learned memory is not validated, the existed learned memory system is discarded and a new learned memory is generated based on updated data or insights.

In a variety of embodiments, the process 1000 may provide a user query and an updated prompt to an AI agent (block 1010). In one example, the user query may represent a request for information, assistance with a task, or the completion of a specific action. In examples, the user query may be a question or problem text provided by a user. In some examples, the updated prompt may include a learned memory.

In many embodiments, the process 1000 may receive an updated automated response from the AI agent for the user query (block 1020). The AI agent may generate the updated automated response for the user query based on the updated prompt. The process 1000 may receive, in response to providing the user query and the updated prompt to the AI agent, the updated automated response from the AI agent for the user query.

In more embodiments, the process 1000 may compare the updated automated response with a validated response of the user query (block 1030). The validated response may refer to a response that has been verified or confirmed as accurate, reliable, and/or relevant to the user query. In examples, the validation response may be provided by a human expert. The process 1000 may compare the updated automated response with the validated response using one of a first large language model, a second large language model, or a third large language model. The one of the first large language model, the second large language model, or the third large language model may compare the updated automated response with the validated response and generate a result of the comparison.

In numerous embodiments, the process 1000 may receive an indication as a result of the comparison (block 1040). For example, as the result of the comparison, the process 1000 may receive an indication that the learned memory associated with the updated prompt has been successfully validated by one of the first large language model, the second large language model, or the third large language model. Alternatively, as the result of the comparison, the process 1000 may receive an indication that the validation of the learned memory associated with the updated prompt has failed, according to one of the first large language model, the second large language model, or the third large language model.

In a number of embodiments, the process 1000 may determine whether the learned memory associated with the updated prompt is successfully validated (block 1045). In a variety of embodiments, the process 1000 may determine whether the learned memory associated with the updated prompt is successfully validated based on the indication received from one of the first large language model, the second large language model, or the third large language model. In yet more embodiments, if the result of the comparison indicates that there is no divergence in the updated automated response compared to the validated response, this may signify that the learned memory has been successfully validated. On the contrary, if the result of the comparison indicates that there one or more output divergences in the updated automated response compared to the validated response, this may signify that the learned memory has not been successfully validated. In further additional embodiments, if the indication that the learned memory is successfully validated is received, the process 1000 may store the learned memory in a database for a configured time-period (block 1050). In an example, the configured time-period may be 30 days.

In many more embodiments, the process 1000 may determine if the configured time-period has expired (block 1055). If the configured time-period has not expired, the process 1000 may continue to determine if the configured time-period has expired (block 1055). If the configured time-period has expired, the process 1000 may delete the stored learned memory from the database (block 1060). In an example, the learned memory may be stored in the database for 30 days after validation. After 30 days, the process 1000 may delete the stored learned memory from the database. In this scenario, the learned memory may no longer be available after 30 days, maintaining optimal database performance and ensuring data relevance. In various embodiments, once the learned memory is stored, the stored learned memory may be automatically deleted upon expiration of the configured time-period.

In still more embodiments, if the indication that the learned memory has failed is received, the process 1000 may re-learn a new learned memory (block 1070). The process 1000 may re-learn the new learned memory using at least one of the first large language model or the second large language model. The re-learning of the new learned memory may be based on at least one of the updated automated response, the validated response, or the user query. In yet additional embodiments, the process 1000 may obtain another updated prompt (block 1080). In an implementation, the process 1000 may obtain the updated prompt based on injecting the new learned memory in a prompt. In further embodiments, upon obtaining the updated prompt, the process 1000 may provide the user query and the updated prompt to the AI agent (block 1010). In an example, the updated prompt may include the new learned memory.

Although a specific embodiment for a process 1000 for re-learning a new learned memory upon an unsuccessful validation of an existing learned memory suitable for carrying out the various steps, processes, methods, and operations described herein is discussed with respect to FIG. 10, any of a variety of systems and/or processes may be utilized in accordance with embodiments of the disclosure. For example, after receiving the indication that the learned memory is successfully validated, the process 1000 may create a plurality of variations of the user query, encode the plurality of variations into embedding vectors, map the learned memory to the embedding vectors, and store at least one of the learned memory or the embedding vectors in a database. In further embodiments, a single large language model may perform tasks associated with each of the first large language model, the second large language model, and the third large language model. For example, the first large language model, the second large language model, and the third large language model may be replaced entirely by the single large language model. The elements depicted in FIG. 10 may also be interchangeable with other elements of FIGS. 1-9 and FIGS. 11-13 as required to realize a particularly desired embodiment.

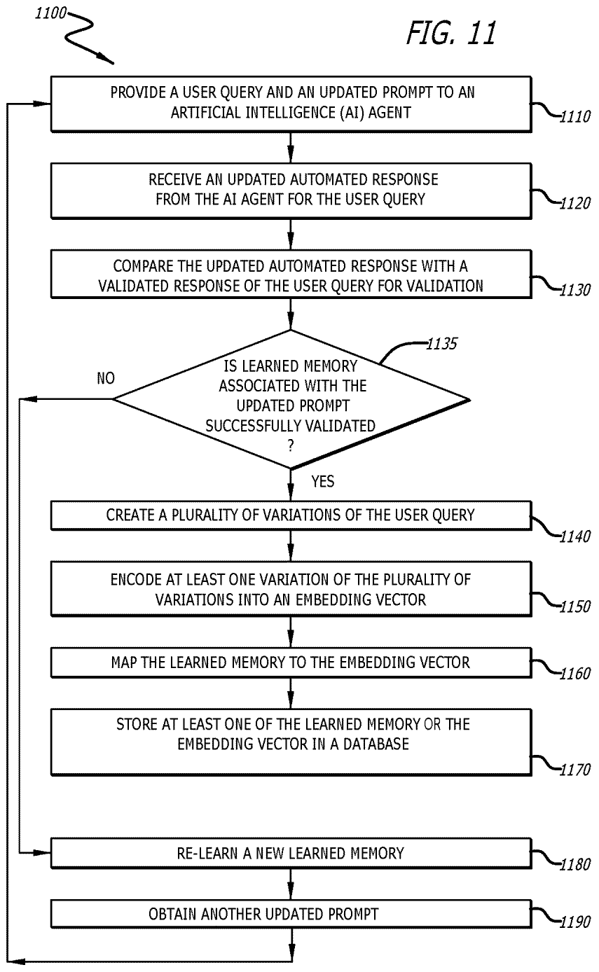

Referring to FIG. 11, a flowchart depicting a process 1100 for mapping a learned memory to one or more variations of a user query in accordance with various embodiments of the disclosure. In a variety of embodiments, the process 1100 may provide a user query and an updated prompt to an AI agent (block 1110). In one example, the user query may represent a request for information, assistance with a task, or the completion of a specific action. In examples, the user query may be a question or problem text provided by a user. Further, the updated prompt may include a learned memory.

In many embodiments, the process 1100 may receive an updated automated response from the AI agent for the user query (block 1120). The AI agent may generate the updated automated response for the user query based on the updated prompt. The process 1100 may receive, in response to providing the user query and the updated prompt to the AI agent, the updated automated response from the AI agent for the user query.

In more embodiments, the process 1100 may compare the updated automated response with a validated response of the user query for validation (block 1130). The validated response may refer to a response that has been verified or confirmed as accurate, reliable, and/or relevant to the user query. In an example, the validated response may be received from a human expert. The process 1100 may compare the updated automated response with the validated response using one of a first large language model, a second large language model, or a third large language model. The one of the first large language model, the second large language model, or the third large language model may compare the updated automated response with the validated response and generate a result of the comparison.

In a number of embodiments, the process 1100 may determine whether the learned memory associated with the updated prompt is successfully validated (block 1135). In a variety of embodiments, the process 1100 may determine whether the learned memory associated with the updated prompt is successfully validated based on the comparison. If it is determined that the learned memory associated with the prompt is successfully validated, the process 1100 may create a plurality of variations of the user query (block 1140).

In many more embodiments, the process 1100 may encode at least one variation of the plurality of variations into an embedding vector (block 1150). In an embodiment, the process 1100 may use any known embedding model to encode the at least one variation of the plurality of variations into the embedding vector. “Embedding vector: may correspond to a numerical representation that captures the semantic meaning of a user query, such as words or images, in a continuous vector space.

In many further embodiments, the process 1100 may map the learned memory to the embedding vector (block 1160). Mapping the learned memory to the embedding vector may indicate associating the learned memory with the embedding vector. In many more embodiments, the process 1100 may store at least one of the learned memory or the embedding vector in a database (block 1170).

In several embodiments, if it is determined that the validation of the learned memory associated with the updated prompt has failed, the process 1100 may re-learn a new learned memory (block 1180). The process 1100 may re-learn the new learned memory using at least one of the first large language model or the second large language model. In examples, the re-learning of the new learned memory is based on at least one of the updated automated response, the validated response, or the user query. In various embodiments, updated automated response may be compared with the validated response using one of the first large language model, the second large language model, or a third large language model. The process 1100 may receive, based on the comparison, an indication that the validation of the learned memory has failed. The process 1100 may re-learn, in response to the indication that the validation of the learned memory has failed, a new learned memory using at least one of the first large language model or the second large language model.

In yet additional embodiments, the process 1100 may obtain another updated prompt (block 1190). The process 1100 may obtain another updated prompt based on inserting or injecting the new learned memory in a prompt. Injecting the new learned memory into the prompt may involve augmenting the prompt with additional information or directives indicated by the new learned memory. In other words, the process 1100 may modify the prompt to incorporate new data, rules, or context, indicated by the new learned memory. In more embodiments, upon obtaining another updated prompt, the process 1100 may provide the user query and the updated prompt to the AI agent (block 1110). In an example, the updated prompt may be the another updated prompt.

Although a specific embodiment for a process 1100 for mapping a learned memory to one or more variations of the user query suitable for carrying out the various steps, processes, methods, and operations described herein is discussed with respect to FIG. 11, any of a variety of systems and/or processes may be utilized in accordance with embodiments of the disclosure. For example, the process 1100 may receive an indication as a result of the comparison or based on the comparison. In examples, the process 1100 may receive an indication that the learned memory associated with the updated prompt successfully validated from one of the first large language model, the second large language model, or a third large language model. In other examples, as the result of the comparison, the process 1100 may receive an indication that validation of the learned memory associated with the updated prompt has failed from one of the first large language model, the second large language model, or a third large language model. The elements depicted in FIG. 11 may also be interchangeable with other elements of FIGS. 1-10 and FIGS. 12-13 as required to realize a particularly desired embodiment.

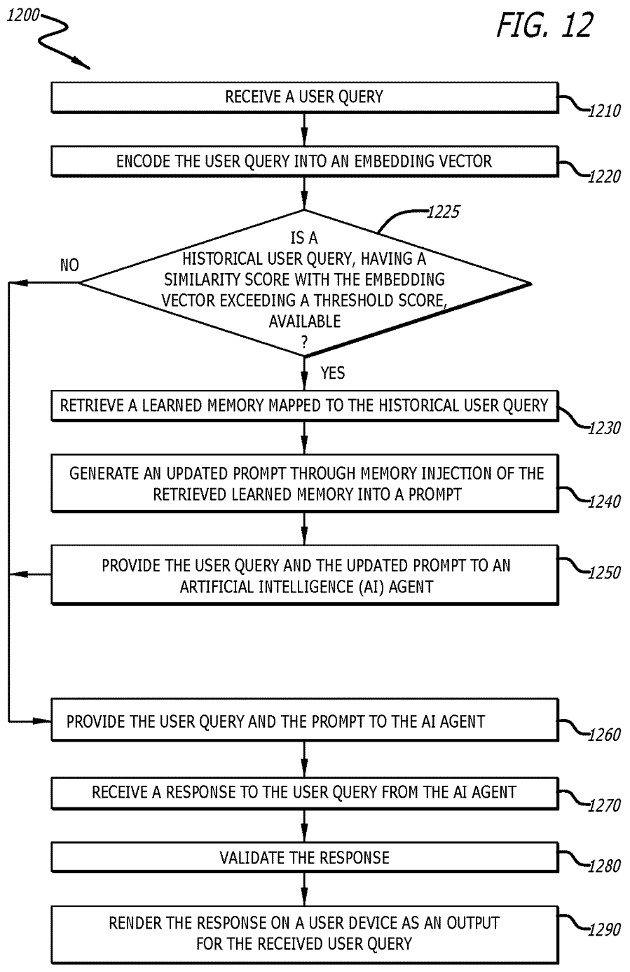

Referring to FIG. 12, a flowchart depicting a process 1200 for validating a response and rendering the validated response on a user device as an output for a received user query in accordance with various embodiments of the disclosure.

In a variety of embodiments, the process 1200 may receive a user query (block 1210). In more embodiments, the process 1200 may receive the user query from a user via a user device. In yet more embodiments, the user query can originate from various sources, including direct user inputs through interfaces such as chatbots or virtual assistants, application programming interfaces (APIs) facilitating automated interactions, and embedded systems such as smart speakers or Internet of Things (IOT) devices that receive voice commands or sensor data.

In further embodiments, the process 1200 may encode the user query into an embedding vector (block 1220). The process 1200 may encode the user query into the embedding vector using any known embedding model. In an example, encoding the user query into the embedding vector may involve transforming the user query (e.g., textual input, voice input, gesture input, image input, or the like) into a numerical representation that captures a semantic meaning of the user query.

In further additional embodiments, the process 1200 may determine whether a historical user query, having a similarity score with the embedding vector exceeding a threshold score, is available (block 1225). In various embodiments, the process 1200 may query a database that includes one or more historical user queries. The process 1200 may query the database to determine whether a historical user query, having a similarity score with the embedding vector exceeding a threshold score, is available in the database. In an example, the similarly score can be a cosine distance, Euclidean distance, dot product, Jaccard similarity score, or the like.

In yet more embodiments, upon determining that the historical user query, having the similarity score with the embedding vector exceeding the threshold score, is available, the process 1200 may retrieve a learned memory mapped to the historical user query (block 1230). For example, the process 1200 may refer a database that stores mapping between embedding vectors and learned memories, and look up using the embedding vector that exceeds the threshold score to retrieve the learned memory.

In yet several embodiments, the process 1200 may generate an updated prompt through memory injection of the retrieved learned memory into a prompt (block 1240). Injecting the retrieved learned memory into the prompt may correspond to augmenting the prompt with additional information to enhance the efficiency of the prompt.

In numerous embodiments, the process 1200 may provide the user query and the updated prompt to an AI agent (block 1250). In response to determining that a historical user query, having a similarity score with the embedding vector exceeding the threshold score, is not available, the process 1200 may provide the user query and the prompt to the AI agent (block 1260). As may be understood, in this case, the prompt does not include the learned memory.

In still more embodiments, the process 1200 may receive a response to the user query from the AI agent (block 1270). In an example, the process 1200 may receive the response to the user query from the AI agent that is generated based on the updated prompt. In additional example, the process 1200 may receive the response to the user query from the AI agent that is generated based on the prompt.

In still more embodiments, the process 1200 may validate the response (block 1280). In an embodiment, the process 1200 may provide the response and a validated response to a large language model for validation. In examples, a result of the validation may include one of a first indication of acceptance of the received response or a second indication of rejection of the received response. In various embodiments, the large language model may compare the response with the validated to validate the response.

In several embodiments, the process 1200 may render the response on a user device as an output for the received user query (block 1290). Rendering the response on the user device may involve presenting the processed output of the user query in a format that is accessible to the user. Rendering the response can encompass various forms of content delivery, for example, audio output, visual output, audio/visual output, haptic output, or the like.

Although a specific embodiment for the process 1200 for validating the response and rendering the validated response on the user device as the output for the received user query suitable for carrying out the various steps, processes, methods, and operations described herein is discussed with respect to FIG. 12, any of a variety of systems and/or processes may be utilized in accordance with embodiments of the disclosure. For example, the process 1200 may identify more than one historical user query. The process 1200 may then retrieve learned memories mapped to the historical user queries. Further, the process 1200 may generate an updated prompt through memory injection of the retrieved learned memories into a prompt. The elements depicted in FIG. 12 may also be interchangeable with other elements of FIGS. 1-11 and FIG. 13 as required to realize a particularly desired embodiment.

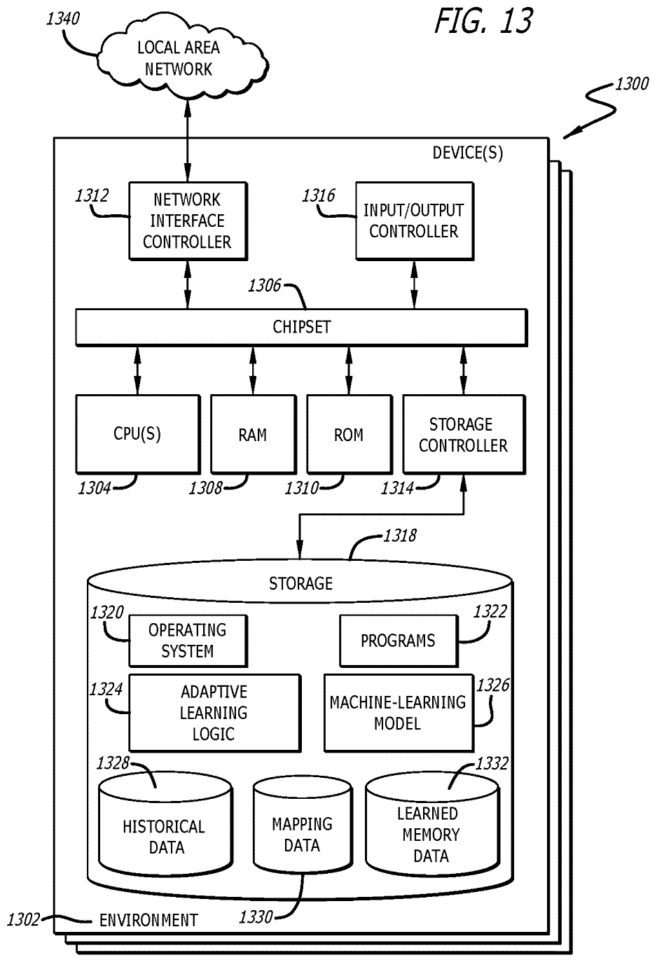

Referring to FIG. 13, a conceptual block diagram of a device 1300 capable of executing components and an adaptive learning logic 1324 for implementing the functionality and embodiments described above is shown. The embodiment of the conceptual block diagram depicted in FIG. 13 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1300 may, in some examples, correspond to a physical device or to a virtual resource described herein. The device 1300 can be a network device (for example, an access point, a switch, or a controller), a client device, or the like in accordance with various embodiments of the disclosure.

In many embodiments, the device 1300 may include an environment 1302 such as a baseboard or a “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In a number of embodiments, one or more processors 1304, such as, but not limited to, central processing units (CPUs) can be configured to operate in conjunction with a chipset 1306. The processor(s) 1304 can be standard programmable CPUs that perform arithmetic and logical operations necessary for the operation of the device 1300.

In a variety of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (RAM) 1308, which can be utilized as the main memory in the device 1300 in some embodiments. The chipset 1306 can further be configured to provide an interface to a computer-readable storage medium such as a read-only memory (ROM) 1310 or a Non-Volatile RAM (NVRAM) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Different embodiments of the device 1300 can be configured to operate in a networked environment using logical connections to remote computing devices and computer systems through a network, such as the network 1340. The chipset 1306 can include functionality for providing network connectivity through a Network Interface Controller (NIC) 1312, which may include a gigabit Ethernet adapter or similar component. The NIC 1312 can be capable of connecting the device 1300 to other devices over the network 1340. It is contemplated that multiple NICs 1312 may be present in the device 1300, connecting the device 1300 to other types of networks and remote systems.

In more embodiments, the device 1300 can be connected to a storage 1318 that provides non-volatile storage for data accessible by the device 1300. The storage 1318 can, for example, store an operating system 1320, programs 1322, historical data 1328, mapping data 1330, and reputation data 1332, which are described in greater detail below. The storage 1318 can be connected to the environment 1302 through a storage controller 1314 connected to the chipset 1306. In additional embodiments, the storage 1318 can include one or more physical storage units. The storage controller 1314 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology utilized to implement the physical storage units, whether the storage 1318 is characterized as primary or secondary storage, and the like. For example, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to the device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1318 can store an operating system 1320 utilized to control the operation of the device 1300. According to one embodiment, the operating system 1320 includes the LINUX operating system. According to another embodiment, the operating system 1320 includes the Windows® server operating system from Microsoft Corporation of Redmond, Washington. According to further embodiments, the operating system 1320 can include the UNIX operating system or one of its variants. It should be appreciated that other operating systems can also be utilized. The storage 1318 can store other system or application programs and data utilized by the device 1300.

In still more embodiments, the storage 1318 or other computer-readable storage media is encoded with computer-executable instructions which, when loaded into the device 1300, may transform the device 1300 from a general-purpose computing system into a special-purpose computer capable of implementing the embodiments described herein. These computer-executable instructions may be stored as programs 1322 (e.g., applications) and transform the device 1300 by specifying how the processor(s) 1304 can transition between states, as described above. In still further embodiments, the device 1300 has access to computer-readable storage media storing computer-executable instructions which, when executed by the device 1300, perform the various processes described above with regard to FIGS. 1-13. In still additional embodiments, the device 1300 can also include computer-readable storage media having instructions stored thereupon for performing any of the other computer-implemented operations described herein.

In some more embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 may not include all of the components shown in FIG. 13, and can include other components that are not explicitly shown in FIG. 13, or may utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In yet various embodiments, the device 1300 can include an adaptive learning logic 1324 that may be configured to generate an updated prompt through memory injection of a learned memory into a prompt. In yet more embodiments, the adaptive learning logic 1324 may operate in the controller. In embodiments where the device 1300 corresponds to the controller, the adaptive learning logic 1324 can be configured to perform various operations such as, but not limited to, receiving one or more input parameters, including at least one of a user query, an automated response, or a validated response, where the automated response and the validated response are associated with the user query; providing, as a first input, the one or more input parameters and an input analysis prompt to a first large language model; receiving an analysis report from the first large language model based on the first input; providing, as a second input, the one or more input parameters and the analysis report to a second large language model; receiving a learned memory from the second large language model based on the second input; and generating an updated prompt through memory injection of the learned memory into a prompt. In embodiments where the device 1300 corresponds to a network device, for example, an access point, the adaptive learning logic 1324 can be configured to perform various operations such as, but not limited to, transmitting a request to one of a first large language model, a second large language model, or a third large language model to compare an automated response with a validation response and receiving a result of the comparison from one of the first large language model, the second large language model, or the third large language model to compare an automated response with a validation response.

Those skilled in the art will recognize that the adaptive learning logic 1324 can include various hardware and/or software deployments and can be configured in a variety of ways. In still yet more embodiments, the adaptive learning logic 1324 can be configured as a standalone device, exist as a logic in another network device, be distributed among various network devices operating in tandem, or remotely operated as part of a cloud-based network management tool. In many further embodiments, one or more servers can be configured with the adaptive learning logic 1324 or can otherwise operate as the adaptive learning logic 1324. In many additional embodiments, the adaptive learning logic 1324 may operate on one or more servers connected to a communication network, for example, the Internet. The communication network can include wired networks or wireless networks. The adaptive learning logic 1324 can be provided as a cloud-based service that can service remote networks, such as, but not limited to a deployed network. Further, in still yet further embodiments, the adaptive learning logic 1324 may be operated as a distributed logic across multiple network devices. In an embodiment, the control plane node can operate as the adaptive learning logic 1324 or may have multiple devices operate as the adaptive learning logic 1324 in a distributed manner.

In several embodiments, the storage 1318 can include historical data 1328. The historical data 1328 may relate to one or more user queriers, corresponding responses, and feedback received from one or more human experts. For example, the historical data 1328 may include, but are not limited to, previous user queries, AI-generated responses associated with the previous user queries, and validated responses associated with the previous user queries. In further additional embodiments, the historical data 1328 may be utilized by the adaptive learning logic 1324 to generate a prompt for an AI agent to respond to a user query.

In several more embodiments, the storage 1318 can include mapping data 1330. The mapping data 1330 may relate to mapped user queries. The mapping data 1330 can include, but is not limited to, learned memories mapped to historical user queries or embedding vectors of historical user queries. In several embodiments, in addition to the historical data 1328, the mapping data 1330 may be utilized by the adaptive learning logic 1324 to generate an updated prompt through memory injection of a learned memory mapped to a historical user query into a prompt. The updated prompt is provided to an AI agent to generate a response to a user query.

In numerous embodiments, the storage 1318 can include learned memory data 1332. The learned data 1332 may include one or more learned memories. A learned memory may refer to information captured from prior interactions or feedback, which may be utilized by an AI agent to improve its performance in generating responses. The learned memory may be created through continuous learning from past data, user queries, and outcomes. This enables the AI agent to provide more accurate, contextually appropriate, and insightful responses in future interactions.

In numerous additional embodiments, data may be processed into a format usable by a machine-learning (“ML”) model 1326 (e.g., feature vectors), and or other pre-processing techniques. The ML model 1326 may be any type of ML model, such as supervised models, reinforcement models, and/or unsupervised models. The ML model 1326 may include one or more of linear regression models, logistic regression models, decision trees, Naïve Bayes models, neural networks, k-means cluster models, random forest models, LLM models, and/or other types of ML models. In an example, the ML model 1326 may include transformer based LLM models. The ML model 1326 may be configured to analyze the historical data 1328, the mapping data 1330, and the learned memory data 1332 for generating prompts for AI agents. In further additional embodiments, the ML model 1326 may be utilized to identify various parameters to include in the historical data 1328, the mapping data 1330, and the learned memory data 1332. For example, the ML model 1326 may analyze the historical data 1328, the mapping data 1330, and the learned memory data 1332 and identify parameters that are required to augment the historical data 1328, the mapping data 1330, and the learned memory data 1332. Once the parameters are identified, the adaptive learning logic 1324 may utilize the parameters to generate prompts for AI agents. For example, the ML model 1326 may be configured to receive the historical data 1328, the mapping data 1330, and the learned memory data 1332. The adaptive learning logic 1324 may then utilize trained models to create learned memories and generate prompts based on the learned memories.

Although a specific embodiment for a device 1300 capable of executing components and the adaptive learning logic 1324 for implementing the functionality and embodiments suitable for carrying out the various steps, processes, methods, and operations described herein is discussed with respect to FIG. 13, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the adaptive learning logic 1324 acts in tandem between the devices. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary”, or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A system, comprising:
a processor; and
a memory communicatively coupled to the processor, wherein the memory comprises an adaptive learning logic that is configured to:
receive one or more input parameters, comprising at least one of a user query, an automated response, or a validated response, wherein the automated response and the validated response are associated with the user query;
provide, as a first input, the one or more input parameters and an input analysis prompt to a first large language model;
receive an analysis report from the first large language model based on the first input;
provide, as a second input, the one or more input parameters and the analysis report to one of the first large language model or a second large language model;
receive a learned memory from one of the first large language model or the second large language model based on the second input; and
generate an updated prompt through memory injection of the learned memory into a prompt.

2. The system of claim 1, wherein the automated response is based on the prompt.

3. The system of claim 2, wherein the automated response is from an Artificial Intelligence (AI) agent, based on the prompt, in response to the user query.

4. The system of claim 1, wherein the adaptive learning logic is further configured to generate the input analysis prompt based on the one or more input parameters.

5. The system of claim 1, wherein the analysis report comprises at least one of: a result of a comparison between the automated response and the validated response, an identification of one or more output divergences in the automated response compared to the validated response, or at least one factor for the one or more output divergences.

6. The system of claim 1, wherein the adaptive learning logic is further configured to validate the learned memory.

7. The system of claim 6, wherein to validate the learned memory, the adaptive learning logic is further configured to:
provide the user query and the updated prompt to an Artificial Intelligence (AI) agent; and
receive, in response to providing the user query and the updated prompt to the AI agent, an updated automated response from the AI agent for the user query.

8. The system of claim 7, wherein to validate the learned memory, the adaptive learning logic is further configured to:
compare the updated automated response with the validated response using one of the first large language model, the second large language model, or a third large language model; and
receive, based on the comparison, an indication that the learned memory is successfully validated.

9. The system of claim 8, wherein the adaptive learning logic is further configured to store at least one of the learned memory or the updated prompt in a database based on the received indication.

10. The system of claim 9, wherein the learned memory is associated with a configured time-period.

11. The system of claim 10, wherein the adaptive learning logic is further configured to delete the stored learned memory from the database upon an expiration of the configured time-period.

12. The system of claim 8, wherein based on the indication that the learned memory is successfully validated, the adaptive learning logic is further configured to:
create a plurality of variations of the user query;
encode at least one variation of the plurality of variations into an embedding vector;
map the learned memory to the embedding vector; and
store at least one of the learned memory or the embedding vector in a database.

13. The system of claim 7, wherein to validate the learned memory, the adaptive learning logic is further configured to:
compare the updated automated response with the validated response using one of the first large language model, the second large language model, or a third large language model;
receive, based on the comparison, an indication that the validation of the learned memory has failed; and
re-learn, in response to the indication that the validation of the learned memory has failed, a new learned memory using at least one of the first large language model or the second large language model.

14. The system of claim 13, wherein the re-learning of the new learned memory is based on at least one of the updated automated response, the validated response, or the user query.

15. A system, comprising:
a processor; and
a memory communicatively coupled to the processor, wherein the memory comprises an adaptive learning logic that is configured to:
receive a user query;
encode the user query into an embedding vector;
identify, from one or more historical user queries, a historical user query that has a similarity score with the embedding vector exceeding a threshold score;
retrieve a learned memory mapped to the identified historical user query;
generate an updated prompt through memory injection of the retrieved learned memory into a prompt; and
receive a response to the user query based on the updated prompt.

16. The system of claim 15, wherein to receive the response to the user query, the adaptive learning logic is further configured to:
provide, as an input, the user query and the updated prompt to an Artificial Intelligence (AI) agent; and
receive the response as an output of the AI agent for the provided input.

17. The system of claim 15, wherein the adaptive learning logic is further configured to validate the received response.

18. The system of claim 17, wherein a result of the validation comprises one of a first indication of acceptance of the received response or a second indication of rejection of the received response.

19. A method, comprising:
receiving one or more input parameters, comprising at least one of a user query, an automated response, or a validated response, wherein the automated response and the validated response are associated with the user query, and the automated response is based on a prompt;
providing as a first input, the one or more input parameters and an input analysis prompt to a first large language model;
receiving an analysis report from the first large language model based on the first input;
providing, as a second input, the one or more input parameters and the analysis report to one of the first large language model or a second large language model;
receiving a learned memory from one of the first large language model or the second large language model based on the second input; and
generating an updated prompt through memory injection of the learned memory into the prompt.

20. The method of claim 19, further comprising:
validating the learned memory; and
storing the learned memory in a database in response to successful validation of the learned memory.
